(19) United States
(12) Patent Application Publication
(10) Pub. No.: US 2025/0034388 A1
(43) Pub. Date: Jan. 30, 2025

(54) MULTI-PHASE LATEX PARTICLE COMPOSITION

(71) Applicant: Hewlett-Packard Development Company, L.P., Spring, TX (US)

(72) Inventors: Jeffrey Matthew Stubbs, San Diego, CA (US); David Michael Ingle, San Diego, CA (US); Holly Novel Keene, San Diego, CA (US); Phillip C. Cagle, San Diego, CA (US)

(21) Appl. No.: 18/707,872

(22) PCT Filed: Nov. 18, 2021
(86) PCT No.: PCT/US2021/059933

§ 371 Date: May 6, 2024

(51) Int. Cl. C08L 33/24; B41J 2/21; C09D 11/322

(52) U.S. Cl. CPC C08L 33/24; C09D 11/322; B41J 2/2114; C08L 2201/52; C08L 2205/02; C08L 2207/53

(57) ABSTRACT

A multi-phase latex particle composition includes at least two different heteropolymers defining at least two different phases. The heteropolymers are selected such that a cumulative percentage of i) any heteropolymers including less than 30% of a C6 or greater (meth)acrylate monomer ranges from about 20 wt % to about 80 wt % of a total particle composition weight; ii) any heteropolymers having a glass transition temperature (T_{g}) ranging from 15° C. to 75° C. ranges from about 20 wt % to about 70 wt % of the total weight; iii) any heteropolymers having a T_{g} greater than 75° C. is greater than 30 wt % of the total weight; iv) any heteropolymers having a T_{g} less than 15° C. is less than 20 wt % of the total weight; and v) an aromatic group monomer is less than 10 wt % of the total weight.

### BACKGROUND

In addition to home and office usage, inkjet technology has been expanded to high-speed, commercial and industrial printing. High-speed printing applications have also expanded the type of media used in inkjet printing beyond traditional porous paper-based media. For example, non-porous, non-paper-based flexible or rigid media are used in product packaging, signage, and other applications. Inkjet printing of aqueous inks on non-porous, non-paper-based media is substantially different than inkjet printing on porous paper-based media. On porous paper-based media, ink drying occurs primarily by penetration of the ink into the media pore structure, and image quality is highly dependent upon the rate of ink penetration. On non-porous, non-paper-based media, the ink does not penetrate into the media, and thus the colorant remains on the surface of the media. As such, image quality is highly dependent upon controlling ink wetting and migration across the non-porous surface. Furthermore, image durability on non-porous media is highly dependent on film formation of a polymeric binder present in the ink, and the chemical resistance and/or adhesion properties of the binder.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A through 1C are schematic illustrations of examples of the multi-phase latex particle composition disclosed herein;

FIG. 2 is a schematic diagram of a printing system;

FIG. 3 includes two bar graphs, where the top bar graph depicts the average Windex test scores (Y axis, scores ranging from 0 to 5) for a comparative ink and several example inks on different types of non-porous, non-paper-based media and the bottom bar graph depicts the average of tape adhesion (Y axis, scores ranging from 0 to 3.5) for the comparative ink and the example inks on the different types of non-porous, non-paper-based media, where the X axis depicts the T_{g} of the lower T_{g} polymer and the % of the lower T_{g} polymer present in the comparative or example multi-phase latex particle composition;

FIG. 4 includes two bar graphs, where the top bar graph depicts the average Windex test scores (Y axis, scores ranging from 0 to 5) for the comparative ink and the example inks on a self-adhesive vinyl (SAV) medium and the bottom bar graph depicts the change in color (DE or ΔE) at 90% elongation (Y axis) for the comparative ink and the example inks on the SAV medium, where the X axis depicts the T_{g} of the lower T_{g} polymer and the % of the lower T_{g} polymer present in the comparative or example multi-phase latex particle composition; and

FIG. 5 includes two bar graphs, where the top bar graph depicts the average Windex test scores (Y axis, scores ranging from 0 to 5) for three comparative inks and three example inks on different types of non-porous, non-paper-based media and the bottom bar graph depicts the average of tape adhesion (Y axis, scores ranging from 0 to 3.5) for the comparative inks and the example inks on the different types of non-porous, non-paper-based media, where the X axis depicts the T_{g} of the lower T_{g} polymer and the % of the lower T_{g} polymer present in the comparative or example multi-phase latex particle composition.

### DETAILED DESCRIPTION

Multi-phase latex particle compositions are disclosed herein which include at least two different heteropolymers defining at least two different phases of the composition. The heteropolymers are selected to balance the hydrophilic and hydrophobic aspects with the glass transition temperatures (T_{g}). More specifically, it has been found that a balance of flexibility and durability can be achieved by controlling the cumulative percentages of heteropolymers, within the latex particle composition, that are formed of specific monomers in specific amounts (which affects hydrophobicity/hydrophilicity) and/or that have specific glass transition temperatures. Flexibility is desirable so that a printed image formed from an ink including the latex particle composition can be elongated and is at least substantially resistant to flaking (i.e., ink chipping off of the media, e.g., when exposing to creasing, bending, etc.). It is also desirable that the printed image formed from the ink including the latex particle exhibit durability, e.g., mechanical strength and chemical resistance. In addition to chemical resistance, mechanical strength and flexibility, the latex particle composition should also enable ink adhesion across a wide range of substrates ranging from more hydrophilic (e.g., vinyl films) to very hydrophobic (e.g., polyolefins). This is achieved by tuning the hydrophobicity of the multiple heteropolymers, independently of the T_{g}, through careful selection of the co-monomers. The multi-phase latex particle compositions disclosed herein exhibit particularly desirable durability, especially in terms of chemical resistance, without having a deleterious impact on the flexibility, while also adhering well to both hydrophilic and hydrophobic printing media.

The multi-phase latex particle compositions disclosed herein are also versatile in that they are suitable for forming printed images on non-porous, non-paper-based media, including both flexible non-porous media and rigid non-porous media. Non-paper-based media does not include cellulose fibers, but rather is made up of synthetic polymeric materials. In some examples, the synthetic polymeric materials are fibers or extruded or cast films. Rigid media may be thicker than flexible media. Rigid media may contain compounded stiffeners or fillers, or may be engineered composites.

As used herein, the term “flexible non-porous, non-paper-based media” refers to a medium that can be fed from a roll without cracking, breaking, ripping, etc. In an example, the flexible non-porous, non-paper-based media may be fed from one media roll through the printer to another media roll (e.g., a take-up roll). Examples of the flexible non-porous, non-paper-based media include self-adhesive vinyl (SAV, which is a plasticized poly(vinyl chloride) (PVC) often used in vehicle wraps, examples of which include 3M IJ180c Controltac cast SAV, Avery MPI 1005 cast SAV, and Avery MPI 2903 calendared SAV), polyethylene terephthalate (PET), synthetic paper (also known as “plastic paper”, which includes compounded polypropylene, examples of which are commercially available from Yupo Corp.), etc. The heteropolymer of the multi-phase latex particle composition with the lower T_{g} provides a soft component to the latex particle composition that allows the ink to resist cracking when the media is flexed, folded or elongated.

Also as used herein, the term “rigid non-porous, non-paper-based media” refers to a medium that is commonly pre-cut to a size that may then be fed through a printer or that may rest on a flat supporting structure or bed while a printing module scans across the surface while applying ink by a digital means (e.g., pen or inkjet module). Rigid media may show indications of flexibility, but generally cannot be fed from a roll without cracking, breaking, ripping, etc. Examples of the rigid non-porous, non-paper-based media include polypropylene, acrylics, polycarbonate, coated aluminum with a polyethylene (PE) core, wood, glass, etc. Examples of polypropylene include INTEPRO® Fluted Polypropylene, COROPLAST® Corrugated Plastic Sheets, Correx Fluted Display Board, and BIPRINT® corrugated sheets.

The heteropolymer of the multi-phase latex particle composition with the higher Tg also helps to ensure that the overall latex particle composition does not remain soft and tacky. This provides anti-blocking properties, which means that the ink films do not stick to each other when printed images are stacked, rolled, etc. This also provides the desired chemical resistance to solvents and aqueous based cleaning products.

Flexible and rigid non-porous media may be hydrophilic or hydrophobic. As noted above, the inks disclosed herein are able to adhere to both hydrophilic and hydrophobic non-porous media.

Throughout this disclosure, a weight percentage that is referred to as “wt % active” refers to the loading of an active component of a dispersion or other formulation that is present, e.g., in the ink. For example, a surfactant may be present in a water-based formulation (e.g., stock solution or dispersion) before being incorporated into the aqueous vehicle. In this example, the wt % actives of the surfactant accounts for the loading (as a weight percent) of the surfactant molecules that are present in the ink, and does not account for the weight of the other components (e.g., water, etc.) that are present in the stock solution or dispersion with the surfactant molecules.

### Multi-Phase Latex Particle Compositions

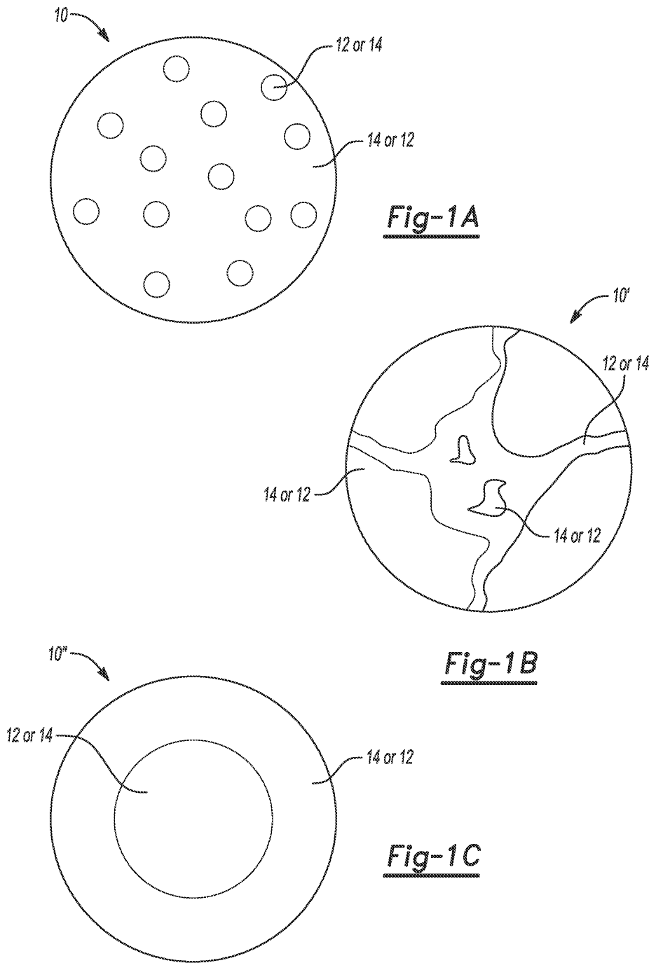

Referring now to FIGS. 1A through 1C, various examples of the multi-phase latex particle compositions 10, 10′, 10″ are schematically depicted. Examples of the morphology of the multi-phase latex particle compositions 10, 10′, 10″ are discussed below, but it is to be understood that the designations “12 or 14” and “14 or 12” indicate that when the first heteropolymer 12 makes up one phase, the second heteropolymer 14 makes up the other phase. As such, in FIG. 1A, the heteropolymer 12 may form the phase that is surrounded by the heteropolymer 14, or the heteropolymer 14 may form the phase that is surrounded by the heteropolymer 12. Moreover, while a few example morphologies are schematically illustrated, the two heteropolymers 12, 14 may reside together in any physically separated configuration. While two-phase examples are shown, it is to be understood that the multi-phase latex particle compositions 10, 10′, 10″ may include additional heteropolymers that form additional physically separated phases.

The multi-phase latex particle compositions 10, 10′, 10″ include at least two different heteropolymers 12, 14 defining at least two different phases of the multi-phase latex particle composition 10, 10′, 10″; wherein the at least two different heteropolymers 12, 14 are selected such that: i) a cumulative percentage of any heteropolymers of the at least two different heteropolymers 12, 14 including less than 30% of a C6 or greater (meth)acrylate monomer ranges from about 20 wt % to about 80 wt % of a total weight of the multi-phase latex particle composition 10, 10′, 10″; ii) a cumulative percentage of any heteropolymers of the at least two different heteropolymers 12, 14, having a glass transition temperature (T_{g}) ranging from 15° C. to 75° C. ranges from about 20 wt % to about 70 wt % of the total weight of the multi-phase latex particle composition 10, 10′, 10″; iii) a cumulative percentage of any heteropolymers of the at least two different heteropolymers having a glass transition temperature (T_{g}) greater than 75° C. is greater than 30 wt % of the total weight of the multi-phase latex particle composition 10, 10′, 10″; iv) a cumulative percentage of any heteropolymers of the at least two different heteropolymers having a glass transition temperature (Tg) less than 15° C. is less than 20 wt % of the total weight of the multi-phase latex particle composition; and v) a cumulative percentage of an aromatic group monomer in the multi-phase latex particle composition 10, 10′, 10″ is less than 10 wt % of the total weight of the multi-phase latex particle composition 10, 10′, 10″. In other words, the multi-phase latex particle composition 10, 10′, 10″ includes i) from about 20 wt % to about 80 wt % of heteropolymer(s) 12, 14 having less than 30% of a C6 or greater (meth)acrylate, ii) from about 20 wt % to about 70 wt % of heteropolymer(s) having a glass transition temperature (T_{g}) ranging from 15° C. to 75° C.; iii) greater than 30 wt % of heteropolymer(s) having a glass transition temperature (T_{g}) greater than 75° C.; iv) less than 20 wt % of heteropolymer(s) having a glass transition temperature (T_{g}) less than 15° C.; and v) less than 10 wt % of aromatic group monomer(s).

The hydrophobic or hydrophilic characteristic of any of the heteropolymers 12, 14 may adjusted by increasing or decreasing the amount of a C6 or greater (meth)acrylate monomer that is present. The term “C6 or greater (meth)acrylate monomer” refers to a monomer that contains an acrylate or methacrylate functional group, where the acrylate or methacrylate functional group is attached, via its single bonded oxygen atom, to a linear or branched alkyl chain or non-aromatic cyclic (ring) that has six (6) or more carbon atoms. When the C6 or greater (meth)acrylate monomer(s) make up 30% (by weight) or more of a given heteropolymer 12, 14, the heteropolymer 12, 14 is more hydrophobic than hydrophilic. In contrast, when the C6 or greater (meth)acrylate monomer(s) make up less than 30% (by weight) of a given heteropolymer 12, 14, the heteropolymer 12, 14 is more hydrophilic than hydrophobic.

Examples of the C6 or greater (meth)acrylate monomers are selected from the group consisting of those set forth in Table 1:

TABLE 1

| C6 or | | |
|---|---|---|
| greater | | |
| (meth) | | |
| acrylate | | |
| monomer | Structure | Tg |
| cyclohexyl acrylate (CHA) | 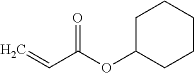 | ~15° C. |
| cyclohexyl metha- crylate (CHMA) | 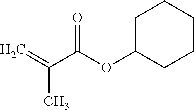 | ~105° C. |
| isobornyl acrylate (iBOA) | 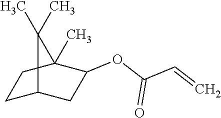 | ~94° C. |
| isobornyl metha- crylate (iBOMA) | 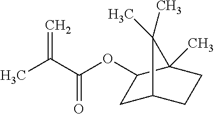 [SMILES: C=C(C)C(=O)OC1CC2CCC1(C)C2(C)C] | ~110° C. |
| 2- ethylhexyl acrylate (2-EHA) | 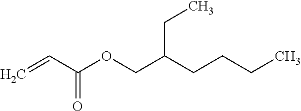 | ~−50° C. |
| 2- ethylhexyl metha- crylate (2- EHMA) | 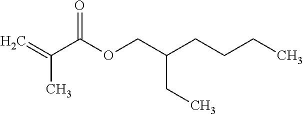 | −10° C. |
| trimethyl- cyclohexyl acrylate (TMCHA) | 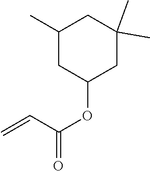 | ~29° C. |
| trimethyl- cyclohexyl metha- crylate (TMC- HMA) | 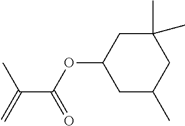 | ~145° C. |
| isodecyl metha- crylate | 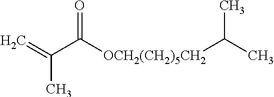 | ~−41º C. |
| lauryl metha- crylate (i.e., dodecyl metha- crylate) | 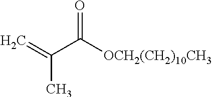 | ~−55° C. |
| iso- tridecyl metha- crylate | 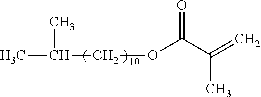 | ~−31° C. |
| stearyl metha- crylate (i.e., octadecyl metha- crylate) | 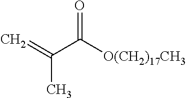 | ~38° C. |
| behenyl metha- crylate | 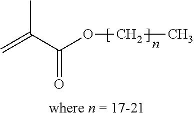 | ~44° C. |
| dicyclo- penta- dienyl acrylate (i.e., dicyclo- pentenyl acrylate) | 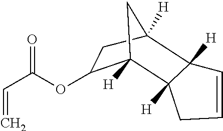 | ~<10° C. |

and combinations of the examples set forth in Table 1.

The C6 or greater (meth)acrylate monomer(s) may be polymerized with functional monomer(s), such as adhesion promoting monomers, acrylonitrile (e.g., to improve chemical resistance), acidic monomers, and/or aromatic monomers, to form some examples of the heteropolymer 12, 14 disclosed herein. In these examples, the heteropolymer 12, 14 includes 30 wt % or more (based on the total weight of the heteropolymer 12, 14) of the C6 or greater (meth)acrylate monomer(s), and thus the heteropolymer 12, 14 is hydrophobic.

Examples of suitable adhesion promoting monomers include n-butyl acryloxy ethyl carbamate (BAEC), monomers including a ureido group, or the like, or combinations thereof. Commercially available examples of monomers with a ureido group include SIPOMER® WAM and SIPOMER® WAM II from Solvay and VISIOMER® MEEU from Evonik. For any single heteropolymer 12, 14, the adhesion promoting monomer may be present in an amount of less than 10 wt % of the total weight of the heteropolymer 12, 14.

Acrylonitrile is an example of a monomer that may be used to improve the chemical resistance of the ink. For any single heteropolymer 12, 14, the acrylonitrile may be present in an amount of less than 10 wt % of the total weight of the heteropolymer 12, 14.

Other monomers, such as diacetone acrylamide (DAAM), may be used that impart chemical resistance through their ability to crosslink with a cross-linker that is added to the ink composition. Dihydrazide crosslinkers may be used, which are capable of reacting with ketone groups in the heteropolymer(s) 15, 17. Monomers that add ketone groups to the heteropolymer 15, 17 include diacetone (meth)acrylamide, diacetone (meth)acrylate, N-(1,1-dimethyl-3-oxobutyl)acrylamide, acetoacetoxyethyl (meth)acrylate, vinyl acetoacetate, crotonaldehyde, 4-vinylbenzaldehyde, (meth)acrolein, vinyl methyl ketone, vinyl ethyl ketone, vinyl butyl ketone, or any other vinyl monomer containing at least one carbonyl. Diamines or hydrazide crosslinkers may also be used, which can crosslink with acetoacetyl groups. Acetoacetyl groups may be incorporated into the heteropolymer(s) 15, 17 using acetoacetoxy alkyl (meth)acrylates, such as 2-acetoacetoxyethyl methacryatate, or acetoacetoxy alkyl (meth)acrylamides. Vinyl silane groups can be incorporated into the heteropolymer(s) 15, 17 and these groups will crosslink with themselves in the presence of moisture. Examples of suitable monomers include triethoxy silane, trimethoxy vinyl silane, and 3-(trimethoxysilyl)propol methacrylate.

Examples of suitable acidic monomers include (meth)acrylic acid, 2-carboxyethyl acrylate, 3-(methacryloyloxy)propionic acid, itaconic acid, citraconic acid, fumaric acid, crotonic acid, maleic acid, or other polymerizable unsaturated carboxylic acids. For any single heteropolymer 12, 14, the acidic monomer may be present in an amount of less than 10 wt % of the total weight of the heteropolymer 12, 14. Some acidic monomers are capable of crosslinking with multifunctional aziridines and/or carbodiimides, and thus can also contribute to improved chemical resistance.

Examples of suitable aromatic monomers include styrene, 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N, N-diphenyl acrylamide, naphthyl methacrylate, naphthyl acrylate, phenyl methacrylate, phenyl acrylate, and combinations thereof. In some examples, styrene is not selected as the aromatic monomer as it can deleteriously affect the performance on non-porous substrates like polypropylene. For any single heteropolymer 12, 14, the aromatic monomer may be present in an amount of 20 wt % or less of the total weight of one of the heteropolymers 12, 14, with the caveat that the cumulative amount of aromatic monomer(s) the multi-phase latex particle composition 10, 10′, 10″ is less than 10 wt % of the total weight of the multi-phase latex particle compositions 10, 10′, 10″. In some examples, each of the heteropolymers 12, 14 in the multi-phase latex particle compositions 10, 10′, 10″ excludes aromatic monomer(s).

In other examples, the C6 or greater (meth)acrylate monomer(s) may be polymerized with one or more of the functional monomers and with C5 or fewer (meth)acrylate monomer(s) to form other examples of the heteropolymer 12, 14 disclosed herein.

The term “C5 or fewer (meth)acrylate monomer” refers to a monomer that contains an acrylate or methacrylate functional group, where the acrylate or methacrylate functional group is attached, via its single bonded oxygen atom, to a linear or branched alkyl chain or non-aromatic cyclic (ring) compound that has five (5) or fewer carbon atoms. Examples of the C5 or fewer (meth)acrylate monomers are selected from the group consisting of those set forth in Table 2:

TABLE 2

| C5 or fewer | | |
|---|---|---|
| (meth)acrylate | | |
| monomer | Structure | Tg |
| ethyl acrylate (EA) | 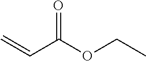 | ~−23° C. |
| ethyl methacrylate (EMA) | 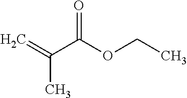 | ~65° C. |
| methyl acrylate (MA) | 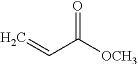 | ~9° C. |
| methyl methacrylate (MMA) | 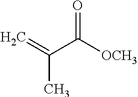 | ~125° C. |
| n-butyl acrylate (n-BA) | 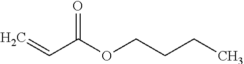 | ~−40° C. |
| n-butyl methacrylate (n-BMA) | 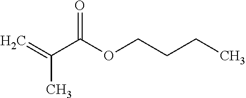 | ~20° C. |
| t-butyl acrylate (t-BA) | 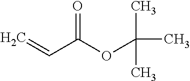 | ~43° C. |
| t-butyl methacrylate (t-BMA) | 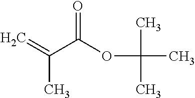 | ~120° C. |
| i-butyl acrylate (i-BA) | 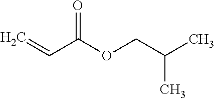 | ~−40° C. |
| i-butyl methacrylate (i-BMA) | 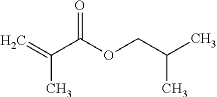 | ~53° C. |
| n-propyl acrylate (n-PA) | 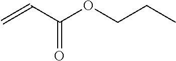 | ~−45° C. |
| n-propyl methacrylate (n-PMA) | 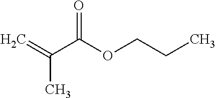 | ~42° C. |
| iso-propyl acrylate (i-PA) | 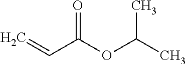 | −8° C. |
| iso-propyl methacrylate (i-PMA) | 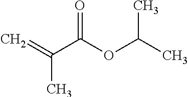 | ~83° C. |
| n-pentyl acrylate | 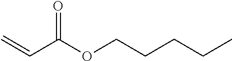 | unknown |
| n-pentyl methacrylate | 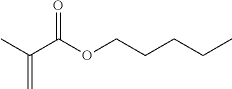 | ~2° C. |
| iso-pentyl methacrylate | 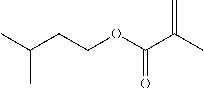 | unknown |

and combinations of the examples set forth in Table 2.

In some of these examples, when it is desirable for the heteropolymer 12 or 14 to be hydrophobic, the C6 or greater (meth)acrylate monomer(s) is/are present in an amount of 30 wt % or more based on the total weight of the heteropolymer 12 or 14 and the C5 or fewer (meth)acrylate monomer(s) is/are present in an amount of 70 wt % or less based on the total weight of the heteropolymer 12 or 14. In one example of the hydrophobic heteropolymer 12, 14, the C6 or greater (meth)acrylate monomer(s) is/are present in an amount ranging from about 60 wt % to about 90 wt % and the C5 or fewer (meth)acrylate monomer(s) is/are present in an amount from greater than 0 wt % to about 40 wt %. In other of these examples, when it is desirable for the heteropolymer 12 or 14 to be hydrophilic, the C6 or greater (meth)acrylate monomer(s) is/are present in an amount of less than 30 wt % based on the total weight of the heteropolymer 12 or 14 and the C5 or fewer (meth)acrylate monomer(s) is/are present in an amount of 60 wt % or more based on the total weight of the heteropolymer 12 or 14. In one example of the hydrophilic heteropolymer 12, 14, the C6 or greater (meth)acrylate monomer(s) is/are present in an amount ranging from about 15 wt % to about 25 wt % and the C5 or fewer (meth)acrylate monomer(s) is/are present in an amount ranging from about 70 wt % to about 80 wt %.

In still other examples, the C5 or fewer (meth)acrylate monomer(s) may be polymerized with the functional monomer(s), such as adhesion promoting monomers, acrylonitrile, diacetone acrylamide or other crosslinkable monomers, acidic monomers, and/or aromatic monomers, to form some other examples of the heteropolymer 12, 14 disclosed herein. In these examples, the heteropolymer 12, 14 does not include the C6 or greater (meth)acrylate monomer(s), and thus the heteropolymer 12, 14 is hydrophilic. In these examples, any of the adhesion promoting monomers, acrylonitrile, the crosslinkable monomers, the acidic monomers, and/or the aromatic monomers may be used.

In the examples disclosed herein, one or more of the heteropolymers 12 or 14 of the multi-phase latex particle compositions 10, 10′, 10″ is hydrophobic and one or more other of the heteropolymers 14 or 12 is hydrophilic. Thus, one or more of the heteropolymers 12 or 14 includes 30% or more of the C6 or greater (meth)acrylate monomer(s), and one or more of the other heteropolymers 14 or 12 includes less than 30% of the C6 or greater (meth)acrylate monomer(s). The hydrophobic heteropolymer(s) 12 or 14 and the hydrophilic heteropolymer(s) 14 or 12 may be present, respectively, in the multi-phase latex particle compositions 10, 10′, 10″ in an amount ranging from about 20 wt % to about 80 wt % of the total weight of the multi-phase latex particle compositions 10, 10′, 10″.

Each heteropolymer 12, 14 in the multi-phase latex particle compositions 10, 10′, 10″ has a glass transition temperature (T_{g}). The selection of each of the monomer(s) used to form the heteropolymer 12, 14 can be used to tune the glass transition temperature (T_{g}) independent of the hydrophobicity/hydrophilicity. The T_{g} of each heteropolymer 12, 14 can be altered by changing the monomer(s) and the amount of the monomer(s) in a given heteropolymer 12, 14. Increasing the amount of monomer(s) with a lower T_{g} can lower the T_{g} of the heteropolymer 12, 14, and increasing the amount of monomer(s) with a higher T_{g} can increase the T_{g} of the heteropolymer 12, 14.

The glass transition temperature T_{g} of each heteropolymer 12, 14 may be estimated using the Fox equation (T. G. Fox, Bull. Am. Physics Soc., Volume 1, Issue No. 3, page 123 (1956)) using the percentage and T_{g} of the monomers in the heteropolymer 12, 14. The glass transition temperature of each heteropolymer 12, 14 may also be determined using DSC (differential scanning calorimetry) according to ASTM D3418.

From about 30 wt % to about 70 wt % of the total weight of the multi-phase latex particle composition 10, 10′, 10″ is made up of heteropolymer(s) 12, 14 having a T_{g} ranging from 15° C. to 75° C., greater than 30% of the total weight of the multi-phase latex particle composition 10, 10′, 10″ is made up of heteropolymer(s) 12, 14 having a T_{g} greater than 75° C., and less than 20% of the total weight of the multi-phase latex particle composition 10, 10′, 10″ is made up of heteropolymer(s) 12, 14 having a T_{g} less than 15° C. In some examples, less than 15% of the heteropolymers 12, 14 in the multi-phase latex particle composition 10, 10′, 10″ has a T_{g} less than 15° C. In other examples, none of the heteropolymers 12, 14 in the multi-phase latex particle composition 10, 10′, 10″ has a T_{g} less than 15° C. In other examples, an additional heteropolymer that has a T_{g} less than 15° C. may be included in the multi-phase latex particle composition 10, 10′, 10″ as long as the conditions set forth herein pertaining to the percentages of heteropolymers 12, 14 with specific glass transition temperatures is satisfied.

In some examples, the hydrophobic heteropolymers 12 or 14 that include 30% or more of the C6 or greater (meth)acrylate monomer(s) have a moderate T_{g} (e.g., from about 50° to 75° C.) or a high T_{g} (greater than 75° C.), and the hydrophilic heteropolymers 12 or 14 that include less than 30% of the C6 or greater (meth)acrylate monomer(s) have a low T_{g} (e.g., from 15° to about 50° C.), a moderate T_{g}, or a high T_{g}. It is to be understood, however, that any one or more of the hydrophobic heteropolymers 12 or 14 and any one of more of the hydrophilic heteropolymers 14 or 12 may be selected to satisfy the glass transition temperature conditions set forth herein.

As mentioned, FIG. 1A through FIG. 1C schematically illustrate different morphologies of the multi-phase latex particle composition 10, 10′, 10″. For any of the morphologies, the heteropolymer 12 is physically separated from the heteropolymer 14 within the multi-phase latex particle composition 10, 10′, 10″. The physical separation of the heteropolymers 12, 14 may manifest itself in a number of different ways. The heteropolymer 12 or 14 may be interdispersed and incompletely coalesced among the heteropolymer 14 or 12, as shown in FIGS. 1A and 1B. In FIG. 1A, the heteropolymer 12 or 14 forms substantially uniform spheres distributed throughout the heteropolymer composition 14 or 12. In FIG. 1B, the heteropolymer 12 or 14 forms a core-like section, where the heteropolymer 14 or 12 substantially surrounds the core-like section and forms random strands/sections that are distributed among the core-like section. In addition to the examples shown in FIGS. 1A and 1B, it is to be understood that any interdispersed and/or incompletely coalesced arrangement of the heteropolymers 12, 14 is contemplated as being suitable for the multi-phase latex particle composition 10, 10′, 10″ morphology. Alternatively, the heteropolymer 12 may form a core that is located within a continuous or discontinuous shell formed of the heteropolymer 14. Still further, the heteropolymer 14 may form a core that is located within a continuous or discontinuous shell formed of the heteropolymer 12. While not shown, some examples of other possible morphologies include the heteropolymers 12, 14 separated into hemispheres, or one of the heteropolymers 12 or 14 present as small nodes at the surface of a sphere of the other of the heteropolymers 14 or 12. As previously mentioned, the morphologies described (whether shown or not shown) are not intended to limit the various physical separations of the heteropolymers 12, 14 that are possible. As such, any physical separation of the heteropolymers 12, 14 within the multi-phase latex particle composition 10, 10′, 10″ is possible.

In an example, the multi-phase latex particle composition 10, 10′, 10″ may be formed using multiple streams (e.g., monomer streams) in a reactor. Prior to the addition of any stream, water and a polymerization seed may be added to the reactor. In an example, the polymerization seed is a vinyl polymer, although other seeds may be used. A seed may be a small, pre-formed heteropolymer particle (e.g., formed by a separate emulsion polymerization or other polymerization process) that replaces early particle formation stages by becoming the locus of polymerization. The seed particle(s) grow through additional polymerization in and/or on the seed, and there may be a one to one (1:1) relationship of the number of seeds to the number of final particles that are formed. The use of polymer seeds permits accurate and reproducible particle size control. An initiator may also be added to or included with the water and heteropolymer seed. Examples of suitable initiators include persulfate, such as a metal persulfate or an ammonium persulfate. In some examples, the initiator may be selected from a sodium persulfate, ammonium persulfate, or potassium persulfate. It is to be understood that the initiator dissolved in water may also be added to the reactor throughout the reaction process.

In an example, two streams are concurrently added to the reactor. One of the two steams is a monomer stream including the monomers used to form one of the heteropolymers 12 or 14. In this example, the monomers may be present in an oil-in-water pre-emulsion. Another of the two streams includes an aqueous solution of a copolymerizable surfactant (e.g., surfactants from the HITENOL® AR series or the HITENOL® KH series or the HITENOL® BC series, e.g. HITENOL® AR-10, AR-20, KH-05, KH-10, BC-10, or BC-30). While several examples of surfactants have been provided, it is to be understood that another copolymerizable surfactant may be used, or a non-polymerizable surfactant may be used. These streams may be added over a targeted feed time, and may be allowed to react at a predetermined temperature for a predetermined time. In an example, the targeted feed time is about 105 minutes, the predetermined temperature is about 77° C., and the predetermined time is about 1 hour. While one example has been given, it is to be understood that other feed times, temperatures, and reaction times may be used.

In another example, these two streams (i.e., the monomer stream used to form one of the heteropolymer compositions 12 or 14 and the aqueous surfactant stream) may be combined into an oil-in-water pre-emulsion, and the pre-emulsion may be fed into the reactor as a single stream over the course of the reaction feed time.

In still other examples, the monomers used to form one of the heteropolymers 12 or 14 could be separated into separate monomer feed streams (e.g., a hydrophobic monomer stream and a functional monomer stream). Each of the monomer streams may be paired with a separate aqueous surfactant stream. In this example, each pair (i.e., one of the monomer streams and one of the aqueous surfactant streams) could be fed into the reactor at a particular time (e.g., the first pair of streams followed by the second pair of streams). Alternatively, in this example, each pair could be combined into its own pre-emulsion, and the pre-emulsions may be fed into the reactor sequentially (i.e., one before the other).

In any of the previously described examples (e.g., two streams, a pre-emulsion stream, etc.), another monomer stream is then introduced. This other monomer stream may be an aqueous emulsion including the monomers used to form the other of the heteropolymers 14 or 12. In addition to water and the various monomers, the other monomer stream may also include any example of the copolymerizable surfactant. The other stream may be added over a targeted feed time, and may be allowed to react at a predetermined temperature for a predetermined time. In an example, the targeted feed time is about 195 minutes, the predetermined temperature is about 85° C., and the predetermined time is about 1 hour. While one example has been given, it is to be understood that other feed times, temperatures, and reaction times may be used.

A chain transfer agent may be introduced with the monomer streams. The chain transfer agent may be added to stop a growing chain by transferring the radical activity to the chain transfer agent, which subsequently starts a new polymerizing chain. This process reduces the molecular weight of the heteropolymer 14 or 12. Examples of suitable chain transfer agents include oil soluble/water insoluble materials, such as mercaptans, e.g., iso-octyl thioglycolate, tert-dodecyl mercaptan, etc., or water soluble materials, such as 1-thioglycerol.

The temperatures used during the polymerization processes may vary depending, in part, on the initaitor used. For persulfate initiated polymerzations of 5 to 6 hours time, the half-life of the polymerization needs to be taken into account. The reaction temperature determines, in part, the persulfate half-life. In an example involving a persulfate initiator, the reaction temperature ranges from about 68° C. to about 80° C. In another example, the reaction temperature is 70° C.+/−2°.

The overall feed time may be longer or shorter, as desired in order to form the multi-phase latex particle composition 10, 10′, 10″. In some examples, the feed time may be proportional to the percentage of the heteropolymers 12, 14 that are to be formed. For example, with a 5 hour feed time and a target composition for the multi-phase latex particle composition 10, 10′, 10″ including about 35 wt % of the heteropolymer 12 and about 65 wt % of the heteropolymer 14, the monomers for the heteropolymer 12 may be fed for 35% of the 5 hour period (about 105 minutes) and the monomers for the heteropolymer 14 may be fed for 65% of the 5 hour period (about 195 minutes). It is to be understood that other feed times may be used that are unrelated to the percentage of the heteropolymers 12, 14 in the multi-phase latex particle composition 10, 10′, 10″.

In addition to the percentage of total monomer in the feeds, the respective polymerization rates (propagation rate coefficients) may be taken into account when setting the feed rates, to allow control over the polymerization kinetics.

The reaction product includes particles of the multi-phase latex particle composition 10, 10′, 10″ in an aqueous emulsion. As such, these particles may be referred to as latex particles. The particle size (i.e., average diameter) of the latex particles may range from about 0.06 μm (about 60 nm) to about 0.4 μm (about 400 nm). In another example, the particle size of the latex particles may range from about 0.1 μm to about 0.3 μm. In some examples, the latex particles within a distribution of the particles can have a median diameter (D50) ranging from about 130 nm to about 230 nm. In an example, the median value may be weighted by volume.

In an example, the aqueous emulsion may include from about from about 20% solids to about 60% solids (e.g., from about 40% solids to about 50% solids, based on the total weight of the aqueous emulsion. The viscosity of the aqueous emulsion may be less than 50 cps, or less than 20 cps (when measured at 25° C. and 50 rpm with a Brookfield viscometer).

With any of these polymerization processes, the heteropolymer 12 may be formed first, followed by the heteropolymer 14, which may result in the heteropolymer 12 forming the substantially uniform spheres of FIG. 1A, the core-like section of FIG. 1B, or the core of FIG. 1C. Alternatively, the heteropolymer 14 may be formed first, followed by the heteropolymer 12, which may result in the heteropolymer 14 forming the substantially uniform spheres of FIG. 1A, the core-like section of FIG. 1B, or the core of FIG. 1C. It is to be understood that the feed order influences the morphology, but does not guarantee the formation of a particular morphology.

Following the polymerization of the heteropolymer 12 and/or of the heteropolymer 14, a cross-linker may be added to promote crosslinking of a crosslinkable monomer (e.g., DAAM, acetoacetoxy ethyl methacrylate, etc.) used in the formation of the heteropolymer 12 and/or 14. Examples of suitable cross-linkers include isophthalic dihydrazide (IPDH), adipic dihydrazide (ADH), oxalic dihydrazide (ODH), succinic dihydrazide, malonic dihydrazide, sebacic dihydrazide, maleic dihydrazide, fumaric dihydrazide, itaconic dihydrazide, terephthalic dihydrazide, and the like. Multifunctional dihydrazides containing three or more hydrazide groups may also be used. Another suitable cross-linkers (e.g., for crosslinking acid groups) includes the commercially available aziridine crosslinker, PZ-33 Polyfunctional Aziridine from Covestro. A diamine may be used to crosslink acetoacetyl groups. In some examples of the multi-phase latex particle composition 12, 14, at least one of the at least two different heteropolymers 12, 14 is crosslinked.

The following are some specific examples of the heteropolymers 12, 14 that can be combined to form examples of the multi-phase latex particle compositions 10, 10′, 10″ disclosed herein.

In a first example, the first heteropolymer 12 of the at least two different heteropolymers 12, 14 includes less than 30% of the C6 or greater (meth)acrylate monomer and has the Tg ranging from 15° C. to 75° C.; and the second heteropolymer 14 of the at least two different heteropolymers 12, 14 includes greater than 30% of the C6 or greater (meth)acrylate monomer and has the Tg greater than 75° C. In this first example, the first heteropolymer 12 is hydrophilic with a low to moderate T_{g} and the second heteropolymer 14 is hydrophobic with a high T_{g}. In this first example, the first heteropolymer 12 may make up from about 50 wt % to about 70 wt % of the total weight of the multi-phase latex particle composition 10, 10′, 10″, and the second heteropolymer 14 may make up from greater than 30 wt % to about 50 wt % of the total weight of the multi-phase latex particle composition 10, 10′, 10″. In this first example, the first heteropolymer 12 may consist of a C5 or less (meth)acrylate monomer, a first adhesion promoting monomer, a first acidic monomer, and a first polymerizable surfactant; and the second heteropolymer 14 may consist of the C6 or greater (meth)acrylate monomer, a second adhesion promoting monomer, a second acidic monomer, a second polymerizable surfactant, the aromatic group monomer, and optionally a chain transfer agent. In this example, the C5 or less (meth)acrylate monomer (of heteropolymer 12) is selected from the group consisting of methyl (meth)acrylate, n-butyl (meth)acrylate, t-butyl (meth)acrylate, i-butyl (meth)acrylate, and combinations thereof; and the C6 or greater (meth)acrylate monomer (of heteropolymer 14) is selected from the group consisting of cyclohexyl (meth)acrylate, isobornyl (meth)acrylate, 2-ethylhexacrylate, and combinations thereof.

In this first example, the heteropolymer 12 forms the substantially uniform spheres of FIG. 1A, the core-like section of FIG. 1B, or the core of FIG. 1C, while the heteropolymer 14 forms the shell.

Table 3 illustrates two examples of this first example of the multi-phase latex particle compositions 10, 10′, 10″, and Table 4 illustrates example characteristics of these two examples. The weight percentages of the various components are within the ranges set forth herein for the heteropolymers 12, 14.

TABLE 3

| | | multi-phase | multi-phase |
|---|---|---|---|
| | | latex particle | latex particle |
| | Component | composition #1 | composition #2 |
| Heteropolymer | C5 or less | n-butyl acrylate | n-butyl acrylate |
| 12 | (meth)acrylate | methyl | methyl |
| | monomer(s) | methacrylate | methacrylate |
| | Adhesion | none | n-butyl acryloxy |
| | promoting | | ethyl carbamate |
| | monomer | | |
| | Crosslinkable | Diacetone | Diacetone |
| | monomer | acrylamide | acrylamide |
| | Acidic monomer | Methacrylic acid | Methacrylic acid |
| | Polymerizable | HITENOL ® | HITENOL ® |
| | surfactant | AR series | AR series |
| Heteropolymer | C6 or greater | cyclohexyl | cyclohexyl |
| 14 | (meth)acrylate | methacrylate | methacrylate |
| | monomer | | |
| | Adhesion | n-butyl acryloxy | n-butyl acryloxy |
| | promoting | ethyl carbamate | ethyl carbamate |
| | monomer(s) | | |
| | Crosslinkable | Diacetone | Diacetone |
| | monomer | acrylamide | acrylamide |
| | Acidic monomer | Methacrylic acid | Methacrylic acid |
| | Polymerizable | HITENOL ® | HITENOL ® |
| | surfactant | AR series | AR series |
| | Aromatic | Phenoxyethyl | Phenoxyethyl |
| | monomer | methacrylate | methacrylate |
| | Chain transfer | Iso-octyl | N/A |
| | agent | thioglycolate | |

TABLE 4

| | | multi-phase | multi-phase |
|---|---|---|---|
| | | latex particle | latex particle |
| | Characteristic | composition #1A | composition #1B |
| Heteropolymer | T_{g} | 55-60 | 55-60 |
| 12 | % of total | 65 | 65 |
| | multi-phase | | |
| | latex particle | | |
| | composition | | |
| | Hydrophilic/ | Hydrophilic | Hydrophilic |
| | Hydrophobic | | |
| Heteropolymer | T_{g} | 90-95 | 90-95 |
| 14 | % of total | 35 | 35 |
| | multi-phase | | |
| | latex particle | | |
| | composition | | |
| | Hydrophilic/ | Hydrophobic | Hydrophobic |
| | Hydrophobic | | |

In a second example, the first heteropolymer 12 of the at least two different heteropolymers 12, 14 includes greater than 30% of the C6 or greater (meth)acrylate monomer and has the Tg ranging from 15° C. to 75° C.; and the second heteropolymer 14 of the at least two different heteropolymers 12, 14 includes less than 30% of the C6 or greater (meth)acrylate monomer and has the Tg greater than 75° C. In this second example, the first heteropolymer 12 is hydrophobic with a low to moderate T_{g} and the second heteropolymer 14 is hydrophilic with a high T_{g}. In this second example, the first heteropolymer 12 may make up from about 30 wt % to about 45 wt % of the total weight of the multi-phase latex particle composition 10, 10′, 10″, and the second heteropolymer 14 may make up from about 55 wt % to about 70 wt % of the total weight of the multi-phase latex particle composition 10, 10′, 10″. In this second example, the first heteropolymer 12 may consist of the C6 or greater (meth)acrylate monomer, at least one adhesion promoting monomer, a first acidic monomer, and a first polymerizable surfactant; and the second heteropolymer may consist of a C5 or less (meth)acrylate monomer, the C6 or greater (meth)acrylate monomer, the at least one adhesion promoting monomer, a second acidic monomer, and a second polymerizable surfactant. In this example, the C6 or greater (meth)acrylate monomer is selected from the group consisting of cyclohexyl (meth)acrylate, isobornyl (meth)acrylate, 2-ethylhexacrylate, and combinations thereof; and the C5 or less (meth)acrylate monomer is selected from the group consisting of methyl (meth)acrylate, n-butyl (meth)acrylate, t-butyl (meth)acrylate, i-butyl (meth)acrylate, and combinations thereof.

In this second example, the heteropolymer 12 forms the substantially uniform spheres of FIG. 1A, the core-like section of FIG. 1B, or the core of FIG. 1C, while the heteropolymer 14 forms the shell.

Table 5 illustrates one example of this second example of the multi-phase latex particle compositions 10, 10′, 10″, and Table 6 illustrates example characteristics of this example. The weight percentages of the various components are within the ranges set forth herein for the heteropolymers 12, 14.

TABLE 5

| | | multi-phase | multi-phase |
|---|---|---|---|
| | | latex particle | latex particle |
| | Component | composition #2A | composition #2B |
| Heteropolymer | C6 or greater | cyclohexyl | cyclohexyl |
| 12 | (meth)acrylate | acrylate | acrylate |
| | monomer(s) | cyclohexyl | cyclohexyl |
| | | methacrylate | methacrylate |
| | Adhesion | n-butyl acryloxy | n-butyl acryloxy |
| | promoting | ethyl carbamate | ethyl carbamate |
| | monomer(s) | | |
| | Crosslinkable | Diacetone | Diacetone |
| | monomer | acrylamide | acrylamide |
| | Acidic monomer | Methacrylic acid | Methacrylic acid |
| | Polymerizable | HITENOL ® | HITENOL ® |
| | surfactant | AR series | AR series |
| Heteropolymer | C5 or less | n-butyl acrylate | n-butyl acrylate |
| 14 | (meth)acrylate | methyl | methyl |
| | monomer(s) | methacrylate | methacrylate |
| | C6 or greater | cyclohexyl | cyclohexyl |
| | (meth)acrylate | (meth)acrylate | (meth)acrylate |
| | monomer(s) | | |
| | Crosslinkable | Diacetone | Diacetone |
| | monomer | acrylamide | acrylamide |
| | Acidic monomer | Methacrylic acid | Methacrylic acid |
| | Polymerizable | HITENOL ® | HITENOL ® |
| | surfactant | AR series | AR series |
| | Aromatic | N/A | Phenoxyethyl |
| | monomer | | methacrylate |

TABLE 6

| | | multi-phase | multi-phase |
|---|---|---|---|
| | | latex particle | latex particle |
| | Characteristic | composition #2A | composition #2B |
| Heteropolymer | T_{g} | 55-60 | 55-60 |
| 12 | % of total | 35 | 35 |
| | multi-phase | | |
| | latex particle | | |
| | composition | | |
| | Hydrophilic/ | Hydrophobic | Hydrophobic |
| | Hydrophobic | | |
| Heteropolymer | T_{g} | 90-95 | 90-95 |
| 14 | % of total | 65 | 65 |
| | multi-phase | | |
| | latex particle | | |
| | composition | | |
| | Hydrophilic/ | Hydrophilic | Hydrophilic |
| | Hydrophobic | | |

### Ink Composition

The multi-phase latex particle composition 10, 10′, 10″ may be included in an ink composition, examples of which will now be described. The ink composition may be suitable for printing via a thermal inkjet printer or a piezoelectric inkjet printer.

The ink composition generally includes a pigment, latex particles made up of any example of the multi-phase latex particle composition 10, 10′, 10″ disclosed herein, and an aqueous vehicle.

Examples of the ink composition include the pigment. The term “pigment” may include particulate dispersible colorants that can be suspended or dispersed in the aqueous vehicle disclosed herein. The pigment itself can be a self-dispersed pigment or a non-self-dispersed pigment.

The pigment may include inorganic pigments or organic pigments of any desirable color, such as black pigments, white pigments, cyan pigments, magenta pigments, yellow pigments, or the like.

Suitable inorganic pigments include, for example, carbon black. However, other inorganic pigments may be suitable, such as titanium oxide, cobalt blue (CoO—Al₂O₃), chrome yellow (PbCrO₄), and iron oxide.

Suitable organic pigments include, for example, azo pigments including diazo pigments and monoazo pigments, polycyclic pigments (e.g., phthalocyanine pigments, such as phthalocyanine blues and phthalocyanine greens, perylene pigments, perinone pigments, anthraquinone pigments, quinacridone pigments, dioxazine pigments, thioindigo pigments, isoindolinone pigments, pyranthrone pigments, and quinophthalone pigments), nitropigments, nitroso pigments, and the like. Suitable examples of phthalocyanine blues include copper phthalocyanine blue and derivatives thereof (Pigment Blue 15). Suitable examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Suitable examples of anthraquinones include Pigment Red 43, Pigment Red 194 (Perinone Red), Pigment Red 216 (Brominated Pyranthrone Red) and Pigment Red 226 (Pyranthrone Red). Suitable examples of perylenes include Pigment Red 123 (Vermillion), Pigment Red 149 (Scarlet), Pigment Red 179 (Maroon), Pigment Red 190 (Red), Pigment Violet 19, Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Suitable examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128 and Pigment Yellow 138, Pigment Yellow 155, Pigment Yellow 83, and Pigment Yellow 213. Such pigments are commercially available in either powder or press cake form from a number of sources including, BASF Corporation, Engelhard Corporation, and Sun Chemical Corporation.

A wide variety of other colored pigments can also be used in the ink composition. While several examples follow, it is to be understood that the list is not intended to be limiting. For example, colored pigments can be blue, brown, cyan, green, white, violet, magenta, red, orange, yellow, as well as mixtures thereof. The following color dispersions are available from Cabot Corp. CABO-JET™ 250C, CABO-JET™ 260M, and CABO-JET™ 270Y. The following color pigments are available from BASF Corp.: PALIOGEN™ Orange, PALIOGEN™ Orange 3040,PALIOGEN™ Blue L 6470, PALIOGEN™ Violet 5100, PALIOGEN™ Violet 5890, PALIOGEN™ Yellow 1520, PALIOGEN™ Yellow 1560, PALIOGEN™ Red 3871K, PALIOGEN™ Red 3340, HELIOGEN™ Blue L 6901F, HELIOGEN™ Blue NBD 7010, HELIOGEN™ Blue K 7090, HELIOGEN™ Blue L 7101F, HELIOGEN™ Blue L6900, L7020, HELIOGEN™ Blue D6840, HELIOGEN™ Blue D7080, HELIOGEN™ Green L8730, HELIOGEN™ Green K 8683, and HELIOGEN™ Green L 9140. The following pigments are available from Ciba-Geigy Corp.: CHROMOPHTAL™ Yellow 3G, CHROMOPHTAL™ Yellow GR, CHROMOPHTAL™ Yellow 8G, IGRAZIN™ Yellow 5GT, IGRALITE™ Rubine 4BL, IGRALITE™ Blue BCA, MONASTRAL™ Magenta, MONASTRAL™ Scarlet, MONASTRAL™ Violet R, MONASTRAL™ Red B, and MONASTRAL™ Violet Maroon B. The following pigments are available from Heubach Group: DALAMAR™ Yellow YT-858-D and HEUCOPHTHAL™ Blue G XBT-583D. The following pigments are available from Hoechst Specialty Chemicals: Permanent Yellow GR, Permanent Yellow G, Permanent Yellow DHG, Permanent Yellow NCG-71,Permanent Yellow GG, Hansa Yellow RA, Hansa Brilliant Yellow 5GX-O2, Hansa Yellow-X, NOVOPERM™ Yellow HR, NOVOPERM™ Yellow FGL, Hansa Brilliant Yellow 10GX, Permanent Yellow G3R-01, HOSTAPERM™ Yellow H4G, HOSTAPERM™ Yellow H3G, HOSTAPERM™ Orange GR, HOSTAPERM™ Scarlet GO, HOSTAPERM™ Pink E, Permanent Rubine F6B, and the HOSTAFINE™ series. The following pigments are available from Mobay Corp.: QUINDO™ Magenta, INDOFAST™ Brilliant Scarlet, QUINDO™ Red R6700, QUINDO™ Red R6713, and INDOFAST™ Violet. The following pigments are available from Sun Chemical Corp.: L74-1357 Yellow, L75-1331 Yellow, and L75-2577 Yellow. Other examples of pigments can include Normandy Magenta RD-2400, Permanent Violet VT2645, Argyle Green XP-111-S, Brilliant Green Toner GR 0991, Sudan Blue OS, PV Fast Blue B2GO1, Sudan III, Sudan II, Sudan IV, Sudan Orange G, Sudan Orange 220, Ortho Orange OR 2673, Lithol Fast Yellow 0991 K, Paliotol Yellow 1840, Lumogen Yellow D0790, Suco-Gelb L1250, Suco-Yellow D1355, Fanal Pink D4830, Cinquasia Magenta, Lithol Scarlet D3700, Toluidine Red, Scarlet for Thermoplast NSD PS PA, E. D. Toluidine Red, Lithol Rubine Toner, Lithol Scarlet 4440, Bon Red C, Royal Brilliant Red RD-8192, Oracet Pink RF, Lithol Fast Scarlet L4300, and white TIPURE R-101. These pigments are available from commercial sources such as Hoechst Celanese Corporation, Paul Uhlich, BASF Corp., American Hoechst, Novartis, Aldrich, DuPont, Ugine Kuhlman of Canada, Dominion Color Company, Magruder, and Matheson.

Examples of black pigments that can be used include carbon pigments. The carbon pigment can be almost any commercially available carbon pigment that provides acceptable optical density and print characteristics. Examples of suitable carbon pigments include carbon black, graphite, vitreous carbon, charcoal, and combinations thereof. Such carbon pigments can be manufactured by a variety of known methods such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as MONARCH™ 1400, MONARCH™ 1300, MONARCH™ 1100, MONARCH™ 1000, MONARCH™ 900, MONARCH™ 880, MONARCH™ 800, MONARCH™ 700, CAB-O-JET™ 200, CAB-O-JET™ 300, REGAL™, BLACK PEARLS, ELFTEX™, MOGUL™, and VULCAN™ pigments; Columbian pigments such as RAVEN™ 7000, RAVEN™ 5750, RAVEN™ 5250, RAVEN™ 5000, and RAVEN™ 3500; Degussa pigments such as Color Black FW 200, RAVEN™ FW 2, RAVEN™ FW 2V, RAVEN™ FW 1, RAVEN™ FW 18, RAVEN™ S160, RAVEN™ FW S170, Special Black™ 6, Special Black™ 5, Special Black™ 4A, Special Black™ 4, PRINTEX™ U, PRINTEX™ 140U, PRINTEX™ V, and PRINTEX™ 140V.

In some examples, the ink composition includes the pigment in an amount of at least 1 wt % active based on the total weight of the ink composition. In some examples, the ink composition includes up to about 20 wt % active pigment by total weight of the ink composition. In some examples, the pigment is included in the ink composition in an amount ranging from about 6 wt % active to about 15 wt % active, or from about 2 wt % active to about 10 wt % active, based on the total weight of the ink composition. When the pigment is incorporated into the ink composition as part of a dispersion (e.g., which also includes water), it is to be understood that these percentages account for the weight percent of solid pigment particles or active pigment particles in the ink composition, and does not account for the total weight percent of the pigment dispersion that may be incorporated in the ink composition.

Any of the pigments, such as carbon, phthalocyanine, quinacridone, azo, or other organic pigments set forth herein, may be made self-dispersing, as long as at least one organic group that is capable of dispersing the pigment is attached to the pigment. The organic group that is attached to the pigment includes at least one aromatic group, an alkyl (e.g., C₁ to C₂₀), and an ionic or ionizable group. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like). The alkyl may be branched or unbranched, substituted or unsubstituted. The ionic or ionizable group may be at least one phosphorus-containing group, at least one sulfur-containing group, or at least one carboxylic acid group.

If the pigment is not self-dispersed, an additional dispersant may be included in pigment dispersion, and thus the ink composition. Examples of suitable dispersants include water-soluble acrylic acid polymers or branched co-polymers of a comb-type structure. Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation. The branched co-polymer of the comb-type structure includes polyether pendant chains and acidic anchor groups attached to the backbone. Specific examples include DISPERBYK®-190 and DISPERBYK®-199, both available from BYK Additives and Instruments, as well as DISPERSOGEN® PCE available from Clariant.

The amount of the dispersant in the pigment dispersion may range from about 0.1 wt % to about 2 wt %, based on the total weight of the dispersion. The pigment dispersion may then be incorporated into the aqueous vehicle so that the dispersant is present in an amount ranging from about 0.01 wt % active to about 0.5 wt % active, based on a total weight of the ink composition. In one of these examples, the dispersant is present in an amount of about 0.04 wt % active, based on a total weight of the ink composition.

In other examples, the ink composition may be unpigmented or substantially lack a pigment. For example, the ink composition may include less than 0.5 wt % of a pigment. In the examples, the ink composition colorless, and may be used as an overcoat composition.

The ink composition also includes latex particles. The latex particles include any of the multi-phase latex particle compositions 10, 10′, 10″ disclosed herein. In an example, the latex particles are present in an amount ranging from about 5 wt % active to about 20 wt % active of a total weight of the ink composition.

The ink composition also includes the aqueous vehicle. The vehicle of the ink composition is an aqueous vehicle because it includes some water. In some examples, the aqueous vehicle may be a water-based vehicle, where water is the main vehicle component, i.e., is present at 50 wt % or higher. The water-based vehicle is particularly suitable when the ink composition is to be jetted via thermal inkjet printing. In other examples, the aqueous vehicle may be a solvent-based vehicle, where a solvent or a mixture of co-solvents is the main vehicle component, i.e., is present at 50 wt % or higher, and water is included as a minor vehicle component, i.e., less than 50 wt %. The solvent-based vehicle is particularly suitable when the ink composition is to be jetted via piezoelectric inkjet printing.

In some examples, the ink composition includes water in an amount of at least about 20 wt %, for example, at least about 30 wt %, or at least about 40 wt %, or at least about 50 wt %, by total weight of the ink composition. In some examples, the ink composition includes up to about 80 wt % water, for example up to about 75 wt %, up to about 60 wt %, or up to about 55 wt %, by total weight of the ink composition. In some examples, the ink composition includes water in an amount ranging from about 20 wt % to about 85 wt % by total weight of the ink composition.

The ink composition also includes a co-solvent or a blend of co-solvents. In some examples, the ink composition includes the co-solvent(s) in an amount of at least about 1 wt %, for example at least about 5 wt %, or at least about 10 wt %, by total weight of the ink composition. In some examples, the ink composition includes the co-solvent(s) in an amount up to about 50 wt %, for example up to about 40 wt %, or up to about 35 wt % by total weight of the ink composition. In some examples, the ink composition includes the co-solvent(s) in an amount ranging from about 1 wt % to about 50 wt % by total weight of the ink composition. In still other examples, the ink composition includes the co-solvent(s) in an amount ranging from about 50 wt % to about 80 wt % by total weight of the ink composition.

In some examples, the co-solvent is a blend including a solvent having a boiling point ranging from about 170° C. to about 215° C. and a solvent having a boiling point of about 220° C. or more. The solvent having a boiling point ranging from about 170° C. to about 215° C. may itself be a blend of solvents, where each solvent of the blend has a boiling point ranging about 170° C. to about 215° C. The solvent having a boiling point of about 220° C. or more may also be a blend of solvents, where each solvent of the blend of solvents has a boiling point of about 220° C. or more. When the blend including a solvent having a boiling point ranging from about 170° C. to about 215° C. and a solvent having a boiling point of about 220° C. or more is used, the ink composition may include from about 10 wt % to about 40 wt % by total weight of the ink composition of the solvent having the boiling point in the range of about 170° C. to about 215° C. and from about 0.1 wt % to about 8 wt % by total weight of the ink composition of the solvent having the boiling point of about 220° C. or more.

In some other examples, the co-solvent is a blend including a solvent having a boiling point ranging from about 170° C. to about 215° C. and a solvent having a boiling point of ranging from about 220° C. to about 285° C. In these examples, the ink composition may include from about 10 wt % to about 40 wt % by total weight of the ink composition of the solvent having the boiling point in the range of about 170° C. to about 215° C., and/or from about 0.5 wt % to about 8 wt % of the solvent having the boiling point in the range of about 220° C. to about 285° C.

Some examples of the aqueous vehicle include the solvent having a boiling point ranging from about 170° C. to about 215° C. In an example, this solvent has a boiling point ranging from about 180° C. to about 215° C. In some examples, this solvent is selected from an aliphatic alcohol, for example a primary aliphatic alcohol, a secondary aliphatic alcohol, or a tertiary aliphatic alcohol. The aliphatic alcohol may be a diol. In some examples, this solvent is an aliphatic alcohol (specifically a diol) containing 10 carbons or less, for example 8 carbons or less, or 6 carbons or less.

Specific examples of the solvent having a boiling point ranging from about 170° C. to about 215° C. may be selected from the group consisting of 1,2-propanediol, 1,2-butanediol, ethylene glycol, 2-methyl-2,4-pentanediol, 1,3-butanediol, 2-methyl-1,3-propanediol, 1,3-propanediol, and combinations thereof. In some examples, the solvent having a boiling point ranging from about 170° C. to about 215° C. is selected from the group consisting of 1,2-propanediol, 1,2-butanediol, ethylene glycol, 2-methyl-2,4-pentanediol, 1,3-butanediol, and combinations thereof. In some other examples, the solvent is 1,2-butanediol. The boiling points of 1,2-propanediol, 1,2-butanediol, ethylene glycol, 2-methyl-2,4-pentanediol, 1,3-butanediol, 2-methyl-1,3-propanediol and 1,3-propanediol are listed in Table 7 below.

TABLE 7

| | Boiling point |
|---|---|
| Solvent | (° C.) |
| propylene glycol (1,2-propanediol) | 188 |
| 1,2-butanediol | 194 |
| ethylene glycol | 196 |
| 2-methyl-2,4-pentanediol (hexylene glycol) | 198 |
| 1,3-butanediol | 203 |
| 2-methyl-1,3-propanediol (MPdiol) | 213 |
| 1,3-propanediol | 214 |

In some examples, the ink composition includes at least about 5 wt % (by total weight of the ink composition) of the solvent having a boiling point ranging from about 170° C. to about 215° C. In some examples, the ink composition includes up to about 40 wt % (by total weight of the ink composition) of the solvent having a boiling point ranging from about 170° C. to about 215° C.

Some examples of the aqueous vehicle include the solvent having a boiling point of about 220° C. or more. In some instance, this solvent may be defined as having a boiling point ranging from about 220° C. to about 285° C. Blends of these solvents may also be used.

The solvent having the boiling point ranging from about 220° C. to about 285° C. may be selected from alcohols (including aliphatic alcohols and aromatic alcohols), esters, glycol ethers, di-and tri-alkylene glycols, amides, lactams and sulfones. In some examples, this solvent is selected from aliphatic alcohols (including primary, secondary and tertiary aliphatic alcohols, including diols), aromatic alcohols, esters, alkylene glycol alkyl ethers (including di-, tri-and tetra-alkylene glycol alkyl ethers), glycol aryl ethers (such as alkylene glycol aryl ethers, including di-and tri-alkylene glycol aryl ethers), di-and tri-alkylene glycols, lactams (such as 2-pyrrolidinone), and sulfones (such as sulfolane or other cyclic sulfones). In some examples, the aliphatic alcohols, esters, glycol alkyl ethers, and glycol aryl ethers may have 20 carbon atoms or less (e.g., 12 carbons or less, 10 carbons or less, etc.).

Specific examples of the solvent having the boiling point ranging from about 220° C. to about 285° C. may be selected from the group consisting of ethylene glycol 2-ethylhexyl ether, dipropylene glycol n-butyl ether, diethylene glycol n-butyl ether, propylene glycol phenyl ether, 2-pyrrolidinone, tripropylene glycol methyl ether, 2,2,4-trimethyl-1,3-pentanediol monoisobutyrate, tripropylene glycol n-propyl ether, tripropylene glycol n-butyl ether, tetraethylene glycol dimethyl ether, and dipropylene glycol phenyl ether. In some examples, the solvent having the boiling point ranging from about 220° C. to about 285° C. may be selected from the group consisting of 2-pyrrolidinone, tripropylene glycol methyl ether, and tripropylene glycol n-butyl ether.

The boiling points of some examples of the solvent having the boiling point ranging from about 220° C. to about 285° C. are listed in Table 8 below.

TABLE 8

| Solvent | Boiling point |
|---|---|
| ethylene glycol 2-ethylhexyl ether (Eastman EEH) | 229 |
| dipropylene glycol n-butyl ether (DOWANOL ™ DPnB) | 230 |
| diethylene glycol n-butyl ether (Butyl Carbitol) | 230 |
| propylene glycol phenyl ether (DOWANOL ™ PPh) | 243 |
| 2-pyrrolidinone | 245 |
| tripropylene glycol methyl ether (DOWANOL ™ TPM) | 245 |
| 2,2,4-trimethyl-1,3-pentanediol monoisobutyrate | 255-261.5 |
| (TEXANOL ™) | |
| tripropylene glycol n-propyl ether | 261 |
| tripropylene glycol n-butyl ether (DOWANOL ™ TPnB) | 274 |
| tetraethylene glycol dimethyl ether (tetraglyme) | 275 |
| dipropylene glycol phenyl ether (DOWANOL ™ DiPPh) | 280 |

In some examples, the ink composition includes at least about 0.1 wt % (by total weight of the ink composition) of the solvent having a boiling point ranging from about 220° C. to about 285° C. In some examples, the ink composition includes up to about 8 wt % (by total weight of the ink composition) of the solvent having a boiling point ranging from about 220° C. to about 285° C.

The aqueous vehicle may also include a variety of additional components suitable for ink compositions. These additional components may include surfactants, buffers, anti-microbial agents, sequestering agents, anti-kogation agents (e.g., for thermal inkjet inks), and/or humectants.

Examples of suitable surfactants that may be included in the aqueous vehicle include siloxane-based gemini surfactants, alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), TEGO® Twin 4000 (siloxane-based gemini surfactant), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Still other suitable non-ionic surfactants are available from Chemours, including the CAPSTONE® fluorosurfactants, such as CAPSTONE® FS-35 (a non-ionic fluorosurfactant).

Whether a single surfactant is used or a combination of surfactants is used, the total amount of surfactant(s) in the ink composition may range from about 0.01 wt % active to about 3 wt % active based on the total weight of the ink composition. In an example, the total amount of surfactant(s) in the ink composition may be about 0.7 wt % active based on the total weight of the ink composition.

Some examples of the aqueous vehicle include a buffer. The buffer may be TRIS (tris(hydroxymethyl)aminomethane or TRIZMA®), TRIS or TRIZMA® hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N, N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris (Hydroxymethyl) methyl-4-aminobutanesulfonic acid), or the like.

In an example, the total amount of buffer(s) in the ink composition ranges from about 0.01 wt % active to about 3 wt % active (based on the total weight of the ink composition).

The aqueous vehicle may also include an anti-microbial agent. Examples of suitable additional anti-microbial agents include the NUOSEPT® series (Ashland Inc.), UCARCIDE™ or KORDEK™ or ROCIMA™ (The Dow Chemical Company), the PROXEL® series (Arch Chemicals), ACTICIDE® B20, and ACTICIDE® M20, and ACTICIDE® MBL (blends of 2-methyl-4-isothiazolin-3-one (MIT), 1,2-benzisothiazolin-3-one (BIT) and Bronopol) (Thor Chemicals), ACTICIDE® MV (a blend of 5-chloro-2-methyl-4-isothiazolin-3-one (CIT or CMIT) and MIT) (Thor Chemicals), AXIDE™ (Planet Chemical), NIPACIDE™ (Clariant), other blends of CIT or CMIT and MIT under the tradename KATHON™ (The Dow Chemical Company), and combinations thereof.

In an example, the total amount of anti-microbial agent(s) in the ink composition ranges from about 0.01 wt % active to about 0.05 wt % active (based on the total weight of the ink composition). In another example, the total amount of additional anti-microbial agent(s) in the ink composition is about 0.04 wt % active (based on the total weight of the ink composition).

Chelating agents (or sequestering agents) may be included in the aqueous vehicle to eliminate the deleterious effects of heavy metal impurities. Examples of suitable chelating agents are selected from the group consisting of methylglycinediacetic acid, trisodium salt (e.g., TRILON® M from BASF Corp.); 4,5-dihydroxy-1,3-benzenedisulfonic acid disodium salt monohydrate; ethylenediaminetetraacetic acid (EDTA); hexamethylenediamine tetra (methylene phosphonic acid), potassium salt; sodium salt of polyacrylic acid; and combinations thereof.

Whether a single chelating agent is used or a combination of chelating agents is used, the total amount of chelating agent(s) in the ink composition may range from greater than 0 wt % active to about 0.5 wt % active based on the total weight of the ink composition. In an example, the chelating agent is present in an amount ranging from about 0.05 wt % active to about 0.2 wt % active based on the total weight of ink composition. In another example, the chelating agent(s) is/are present in the ink composition in an amount of about 0.05 wt % active (based on the total weight of the ink composition). In an example, the chelating agent may be present in an amount as low as 400 ppm.

An anti-kogation agent may also be included in the aqueous vehicle when the ink composition is a thermal inkjet ink. Kogation refers to the deposit of dried ink solids on a heating element of a thermal inkjet printhead. Anti-kogation agent(s) is/are included to assist in preventing the buildup of kogation. In some examples, the anti-kogation agent may improve the jettability of the thermal inkjet ink. Examples of suitable anti-kogation agents include oleth-3-phosphate (commercially available as CRODAFOS™ O3A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The anti-kogation agent may be present in the thermal inkjet ink in an amount ranging from about 0.1 wt % active to about 1.5 wt % active, based on the total weight of the ink composition. In an example, the anti-kogation agent is present in an amount of about 0.5 wt % active, based on the total weight of the ink composition.

The aqueous vehicle may also include a humectant. An example of a suitable humectant is ethoxylated glycerin having the following formula:

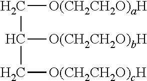

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the ink composition ranges from about 3 wt % active to about 10 wt % active, based on the total weight of the ink composition.

To form examples of the ink composition, the aqueous vehicle, the aqueous emulsion including the latex particles of the multi-phase latex particle compositions 10, 10′, 10″, and the pigment dispersion are combined. In some examples, additional water or other main solvent may be added to the ink composition.

### Printing Method

The ink composition disclosed herein may be used in a printing method. An example of the printing method involves inkjet printing the ink composition onto a non-porous substrate, the ink composition including the pigment, the latex particles made up of the multi-phase latex particle composition 10, 10′, 10″ disclosed herein; and the aqueous vehicle. As a result of printing, an ink layer forms on the non-porous substrate. The ink layer formed on the non-porous substrate includes the inkjet ink composition, including the aqueous vehicle, the pigment, and the latex particles.

In some examples, the method of printing further includes curing the latex particles in the ink layer on the non-porous substrate. Curing of the latex particles forms a polymeric film on the surface of the non-porous substrate. The polymeric film improves the chemical resistance, durability, stretchability, color retention after stretching, and adhesion of the image printed using the ink composition.

In order for the latex particles to be cured, water may first be evaporated from the ink layer, and then any one or more of the co-solvents may be at least partially evaporated from the ink layer. Evaporation enables the latex particles to come into close contact with each other. Once the latex particles come into close contact (due to the at least partial evaporation of water and co-solvent(s)), the latex particles may coalesce by the intermingling of polymer chains between adjacent latex particles to cure the latex particles and form a polymeric film. In order for the latex particles to be cured, the temperature of curing should be above the minimum film formation temperature (MFFT) of the applied ink layer. Pigment particles, where present, remain in the ink layer and are embedded within the polymeric film upon curing of the latex particles.

Water is evaporated from the printed ink composition (i.e., the ink layer) before the co-solvent(s) are at least partially removed (evaporated), as water has a higher volatility (e.g., lower boiling point) than the co-solvent(s).

In examples where the aqueous vehicle includes the solvent having a boiling point ranging from about 170° C. to about 215° C. and the solvent having a boiling point ranging from about 220° C. to about 285° C., the solvent having the lower boiling point is evaporated, or at least partially evaporated, before the solvent having the higher boiling point, again due to the higher volatility of the solvent having the lower boiling point. The solvent having the higher boiling point remains in the ink layer after the water has been evaporated and the solvent with the lower boiling point has been at least partially evaporated.

The inclusion of the solvent having a boiling point of less than about 215° C. in the inkjet ink composition allows for fast drying of the ink composition to enable high throughput through the printing system. The presence of the higher boiling point solvent(s) in the ink composition, which remain in the ink layer after evaporation of the water and at least partial evaporation of the solvent having a boiling point of less than about 215° C., ensures that the MFFT of the ink layer remains lowered during the curing process. All of the solvents may be evaporated upon completion of curing.

As discussed, the curing of the latex particles includes evaporating water from the ink layer. In other examples, the curing the latex particles includes evaporating water and at least a portion of the co-solvent(s) from the ink layer. Evaporation of water and at least a portion of the co-solvent(s) allows the latex particles within the ink layer to coalesce into a film (i.e., allows the particles to cure). Evaporation may be facilitated in a printing system by providing heat and/or airflow. Heating may be conductive, radiative, or convective heating. Airflow may include parallel or impinging airflow. In some examples, heating the ink layer to evaporate water and at least a portion of the co-solvent(s) includes heating the ink layer to a temperature greater than the MFFT and such that the temperature of the non-porous substrate is maintained below a temperature at which deformation (e.g., warping) of the non-porous substrate occurs. For example, heating the ink layer may be accomplished such that the non-porous substrate reaches a temperature of less than about 70° C., for example about 65° C. or less.

In some examples, curing the latex particles includes evaporating substantially all of the water from the ink layer, for example evaporating at least about 95 wt %, or at least about 99 wt %, or at least about 99.5 wt % of the water present in the inkjet ink composition printed as the ink layer. In some examples, curing the latex particles includes evaporating all of the water from the ink layer so that no water remains in the ink layer.

As previously mentioned, curing the latex particles may also involve evaporating at least a portion of the co-solvent(s). In an example, a major amount of the co-solvent(s) of the ink composition printed as the ink layer may be evaporated from the ink layer. In some examples, evaporating at least a portion of the co-solvent(s) includes evaporating at least about 80 wt %, or at least about 90 wt %, or at least about 99 wt % of the solvent having a boiling point ranging from about 170° C. to about 215° C. present in the ink composition printed as the ink layer. In some instances, all of the solvents are evaporated upon completion of curing.

In other examples, the solvent having a boiling point of about 220° C. or more is not evaporated from the ink layer during curing of the latex particles. In some examples, at least a portion of the solvent having a boiling point of about 220° C. remains in the ink layer after curing of the latex polymer.

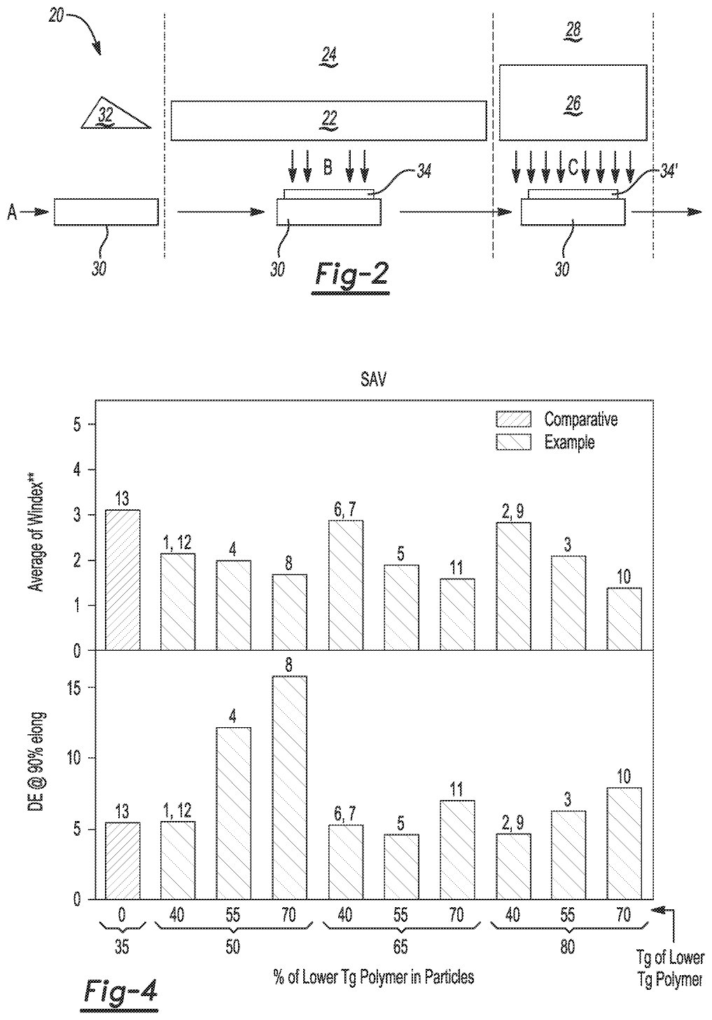

Referring now to FIG. 2, a schematic diagram of a printing system 20 including an inkjet printer 22 in a printing zone 24 of the printing system 20 and a drier 26 positioned in a curing zone 28 of the printing system 20. A non-porous substrate 30 may be transported through the printing system 20 along the path shown by arrow A such that the non-porous substrate 30 is first fed to the printing zone 24, where an example of the ink composition disclosed herein is inkjet printed (as shown by arrows B) onto the non-porous substrate 30 by the inkjet printer 22 to form an ink layer 34 on the non-porous substrate 30. The ink layer 34 disposed on the non-porous substrate 30 may be heated in the printing zone 24 (for example, the air temperature in the printing zone 24 may range from about 10° C. to about 90° C.) such that water may be evaporated from the ink layer 34. In some examples, the printing system 20 also includes a fan 32 for blowing the air over the non-porous substrate passing through the printing zone 24 to evaporate water from the ink layer 34. The non-porous substrate 30 (having the ink layer 34 printed thereon) may then be transported to the curing zone 28 where the ink layer 34 is heated to a temperature above the MFFT of the ink layer 34 to initiate curing and form the polymeric film 34′. In one example, the air temperature in the curing zone 28 may range from about 60° C. to about 140° C. In the curing zone 28, warm/hot air is blown onto the non-porous substrate 30 (as shown by arrows C) such that the water and the solvent(s) are at least partially evaporated from the ink layer 34 and the latex particles are heated to a temperature above the MFFT of the ink layer 34.

To further illustrate the present disclosure, examples are given herein. It is to be understood that these examples are provided for illustrative purposes and are not to be construed as limiting the scope of the present disclosure

### EXAMPLES

### Example 1

Twelve examples of the multi-phase latex particle composition disclosed herein were prepared. One comparative example multi-phase latex particle composition was also prepared. The comparative example multi-phase latex particle composition included 35% of a low T_{g} polymer having a glass transition temperature of 0° C. The process for preparing the example and comparative example multi-phase latex particle compositions generally included: heating deionized water to about 77° C. with mechanical agitation in a reactor; at 77° C., adding a latex seed and an aqueous solution of potassium persulfate to the reactor; and sequentially adding two monomer streams (stage 1 and stage 2) to the reactor over 300 minutes.

Table 9 sets forth the monomers that were used, and identifies the type of each monomer.

TABLE 9

| Monomer | Type of Monomer |
|---|---|
| n-butyl methacrylate | C5 or fewer (meth)acrylate monomer |
| n-butyl acrylate | C5 or fewer (meth)acrylate monomer |
| isobutyl methacrylate | C5 or fewer (meth)acrylate monomer |
| methyl methacrylate | C5 or fewer (meth)acrylate monomer |
| cyclohexyl methacrylate | C6 or greater (meth)acrylate monomer |
| cyclohexyl acrylate | C6 or greater (meth)acrylate monomer |
| diacetone acrylamide | crosslinkable monomer |
| methacrylic acid | acidic monomer |
| phenoxyethyl methacrylate | aromatic monomer |
| butyl acryloyloxyethyl | adhesion promoting monomer |
| carbamate | |
| iso-octyl thioglycolate | chain transfer agent |

Table 10A and 10B set forth some properties of the examples multi-phase latex particle compositions. Tables 10A and 10B also sets forth the following with regard to each of the first and second stage heteropolymers of the example multi-phase latex particle compositions: % of total polymer present in the multi-phase latex particle composition, T_{g} estimated using the Fox equation, the feed time of the monomer stream to the reactor, and the composition of the monomer stream (wt % active). Table 10C sets forth the same information for the comparative example multi-phase latex particle composition.

TABLE 10A

| | | | | | | |
|---|---|---|---|---|---|---|
| Example ID | 1 | 2 | 3 | 4 | 5 | 6 |

Latex Particle Composition Properties

| | | | | | | |
|---|---|---|---|---|---|---|
| solids content | 37.1% | 36.9% | 37.6% | 37.5% | 37.3% | 37.4% |
| (%) | | | | | | |
| particle size | 221 | 218 | 219 | 217 | 224 | 224 |
| (D50, nm) | | | | | | |

First Stage Heteropolymer

| | | | | | | |
|---|---|---|---|---|---|---|
| % of total | 50% | 80% | 80% | 50% | 65% | 65% |
| polymer | | | | | | |
| Tg (° C.) | 40 | 40 | 55 | 55 | 55 | 40 |
| (estimate) | | | | | | |
| feed time to | 150 | 210 | 210 | 150 | 210 | 210 |
| reactor (min) | | | | | | |

composition

| | | | | | | |
|---|---|---|---|---|---|---|
| n-butyl | 55.5% | 55.5% | 69.5% | 69.5% | 69.5% | 55.5% |
| methacrylate | | | | | | |
| n-butyl acrylate | 14.0% | 14.0% | 0.0% | 0.0% | 0.0% | 14.0% |
| isobutyl | 0.0% | 0.0% | 0.0% | 0.0% | 0.0% | 0.0% |
| methacrylate | | | | | | |
| methyl | 25.0% | 25.0% | 25.0% | 25.0% | 25.0% | 25.0% |
| methacrylate | | | | | | |
| diacetone | 3.0% | 3.0% | 3.0% | 3.0% | 3.0% | 3.0% |
| acrylamide | | | | | | |
| methacrylic | 1.5% | 1.5% | 1.5% | 1.5% | 1.5% | 1.5% |
| acid | | | | | | |
| HITENOL ® | 1.0% | 1.0% | 1.0% | 1.0% | 1.0% | 1.0% |
| AR10 | | | | | | |

Second Stage Heteropolymer

| | | | | | | |
|---|---|---|---|---|---|---|
| % of total | 50% | 20% | 20% | 50% | 35% | 35% |
| polymer | | | | | | |
| Tg (° C.) | 95 | 95 | 95 | 95 | 95 | 95 |
| (estimate) | | | | | | |
| feed time to | 150 | 90 | 90 | 150 | 90 | 90 |
| reactor (min) | | | | | | |

composition

| | | | | | | |
|---|---|---|---|---|---|---|
| cyclohexyl | 72.0% | 72.0% | 72.0% | 72.0% | 72.0% | 72.0% |
| methacrylate | | | | | | |
| phenoxyethyl | 14.0% | 14.0% | 14.0% | 14.0% | 14.0% | 14.0% |
| Methacrylate | | | | | | |
| butyl | 5.0% | 5.0% | 5.0% | 5.0% | 5.0% | 5.0% |
| acryloyloxyethyl | | | | | | |
| carbamate | | | | | | |
| diacetone | 3.0% | 3.0% | 3.0% | 3.0% | 3.0% | 3.0% |
| acrylamide | | | | | | |
| methacrylic | 4.0% | 4.0% | 4.0% | 4.0% | 4.0% | 4.0% |
| acid | | | | | | |
| iso-octyl | 1.0% | 1.0% | 1.0% | 1.0% | 1.0% | 1.0% |
| thioglycolate | | | | | | |
| HITENOL ® | 1.0% | 1.0% | 1.0% | 1.0% | 1.0% | 1.0% |
| AR10 | | | | | | |

TABLE 10B

| | | | | | | |
|---|---|---|---|---|---|---|
| Example ID | 7* | 8 | 9** | 10 | 11 | 12*** |

Latex Particle Composition Properties

| | | | | | | |
|---|---|---|---|---|---|---|
| solids content | 37.4% | 36.7% | 36.9% | 37.2% | 37.5% | 37.1% |
| (%) | | | | | | |
| particle size | 224 | 219 | 218 | 222 | 236 | 221 |
| (D50, nm) | | | | | | |

First Stage Heteropolymer

| | | | | | | |
|---|---|---|---|---|---|---|
| % of total | 65% | 50% | 80% | 80% | 65% | 50% |
| polymer | | | | | | |
| Tg (° C.) | 40 | 70 | 40 | 70 | 70 | 40 |
| (estimate) | | | | | | |
| feed time to | 210 | 150 | 210 | 210 | 210 | 150 |
| reactor (min) | | | | | | |

composition

| | | | | | | |
|---|---|---|---|---|---|---|
| n-butyl | 55.5% | 29.5% | 55.5% | 29.5% | 29.5% | 55.5% |
| methacrylate | | | | | | |
| n-butyl acrylate | 14.0% | 0.0% | 14.0% | 0.0% | 0.0% | 14.0% |
| isobutyl | 0.0% | 40.0% | 0.0% | 40.0% | 40.0% | 0.0% |
| methacrylate | | | | | | |
| methyl | 25.0% | 25.0% | 25.0% | 25.0% | 25.0% | 25.0% |
| methacrylate | | | | | | |
| diacetone | 3.0% | 3.0% | 3.0% | 3.0% | 3.0% | 3.0% |
| acrylamide | | | | | | |
| methacrylic | 1.5% | 1.5% | 1.5% | 1.5% | 1.5% | 1.5% |
| acid | | | | | | |
| HITENOL ® | 1.0% | 1.0% | 1.0% | 1.0% | 1.0% | 1.0% |
| AR10 | | | | | | |

Second Stage Heteropolymer

| | | | | | | |
|---|---|---|---|---|---|---|
| % of total | 35% | 50% | 20% | 20% | 35% | 50% |
| polymer | | | | | | |
| Tg (° C.) | 95 | 95 | 95 | 95 | 95 | 95 |
| (estimate) | | | | | | |
| feed time to | 90 | 150 | 90 | 90 | 90 | 150 |
| reactor (min) | | | | | | |

composition

| | | | | | | |
|---|---|---|---|---|---|---|
| cyclohexyl | 72.0% | 72.0% | 72.0% | 72.0% | 72.0% | 72.0% |
| methacrylate | | | | | | |
| phenoxyethyl | 14.0% | 14.0% | 14.0% | 14.0% | 14.0% | 14.0% |
| Methacrylate | | | | | | |
| butyl | 5.0% | 5.0% | 5.0% | 5.0% | 5.0% | 5.0% |
| acryloyloxyethyl | | | | | | |
| carbamate | | | | | | |
| diacetone | 3.0% | 3.0% | 3.0% | 3.0% | 3.0% | 3.0% |
| acrylamide | | | | | | |
| methacrylic | 4.0% | 4.0% | 4.0% | 4.0% | 4.0% | 4.0% |
| acid | | | | | | |
| iso-octyl | 1.0% | 1.0% | 1.0% | 1.0% | 1.0% | 1.0% |
| thioglycolate | | | | | | |
| HITENOL ® | 1.0% | 1.0% | 1.0% | 1.0% | 1.0% | 1.0% |
| AR10 | | | | | | |

*Same as Example 6
**Same as Example 2
***Same as Example 12

TABLE 10C

| | |
|---|---|
| Comparative Example ID | 13 |

Latex Particle Composition Properties

| | |
|---|---|
| solids content (%) | 38.0% |
| particle size (D50, nm) | 240 |

First Stage Heteropolymer

| | |
|---|---|
| % of total polymer | 35% |
| Tg (° C.) (estimate) | 0 |
| feed time to reactor (min) | 105 |

composition

| | |
|---|---|
| n-butyl acrylate | 62.75% |
| methyl methacrylate | 34.50% |
| methacrylic acid | 1.50% |
| HITENOL ® AR10 | 1.25% |

Second Stage Heteropolymer

| | |
|---|---|
| % of total polymer | 65% |
| Tg (° C.) (estimate) | 90 |
| feed time to reactor (min) | 195 |

composition

| | |
|---|---|
| cyclohexyl methacrylate | 69.3% |
| cyclohexyl acrylate | 10.0% |
| phenoxyethyl methacrylate | 14.0% |
| methacrylic acid | 4.0% |
| HITENOL ® AR10 | 2.7% |

Each of the example and comparative multi-phase latex particle compositions was incorporated into an inkjet ink composition at 10 wt %. The ink vehicle was the same for each of the inks, and this composition is shown in Table 11A.

TABLE 11A

| Ink Component | Wt % Active |
|---|---|
| Black or cyan pigment | 2.6 or 1.7 |
| co-solvent | 20.5 |
| surfactants | 0.5 |
| anti-kogation agent | 0.2 |
| water | Balance |

An overcoat was also used. The overcoat fluid composition is shown in Table 11B.

TABLE 11B

| Overcoat Component | Wt % Active |
|---|---|
| wax | 3.0 |
| multi-phase latex particles | 9.0 |
| co-solvent | 25.5 |
| surfactants | 0.5 |
| anti-kogation agent | 0.2 |
| anti-microbial | 0.002 |
| water | Balance |

Each of the example inks (1-12) and the comparative example ink (13) were inkjet printed (using a thermal inkjet printer) on three different rigid media, including PLEXIGLAS® (acrylic sheet), DIBOND® (aluminium composite panel), and INTEPRO® (fluted polypropylene), and on two different flexible media, including LINTEC® E2201 (polyethylene terephthalate) and self-adhesive vinyl (SAV). Some of the overcoat fluid was applied with the example inks (so the two fluids interspersed) and some of the overcoat fluid was printed over the example inks. The printed media were then exposed to heat. The temperature used depended on the type of media being used: PLEXIGLAS® ˜70° C., DIBOND® ˜85° C., INTEPRO® ˜70° C., LINTEC® E2201 ˜90° C., and SAV ˜85° C.

Each example print 1-12 and comparative example print 13 was exposed to a chemical resistance test. For this test, a TABER® abrasion tool was used. The cloth of the abrasion tool was dipped in WINDEX® glass cleaner and was rubbed across 3 mm patches of each print. 10 rub cycles were performed on the DIBOND®, INTEPRO®, PLEXIGLAS® and LINTEC® E2201 media, and 20 rub cycles were performed on the SAV media. All of the tested patches were visually inspected for ink defects, such as ink removal, smear, etc., and graded according to the scale described in Table 12A.

The example prints (1-12) and comparative example print (13) generated on PLEXIGLAS® (acrylic sheet), DIBOND® (aluminium composite panel), INTEPRO® (fluted polypropylene), and LINTEC® E2201 (polyethylene terephthalate) were also exposed to a tape adhesion test (ASTM D3359 cross-hatch tape adhesion test). For this test, cuts in a cross-hatch pattern were made in the prints, and a piece of pressure-sensitive tape was secured over the cross-hatch pattern. The tape was subsequently removed. All of the tested patches were visually inspected for ink defects, such as ink removal, smear, etc., and graded according to the scale described in Table 12B.

TABLE 12A

| Score | Description - Grading Windex Samples |
|---|---|
| 0-1 | No defects observed |
| 2 | Very minor defects at 1M distance |
| 3 | Unacceptable level of defects, some ink removal |
| 4 | High level of defects, significant ink removal |
| 5 | Severe defects and extensive ink removal |

TABLE 12B

| Score | Description - Grading Tape Adhesion |
|---|---|
| 0 | No ink removal (=5B on ASTM3359 scale) |
| 1 | Less than 5% ink removal (=4B on ASTM3359 scale) |
| 2 | 5%-15% ink removal (=3B on ASTM3359 scale) |
| 3 | 15%-35% ink removal (=2B on ASTM3359 scale) |
| 4 | 35%-65% ink removal (=1B on ASTM3359 scale) |
| 5 | >65% ink removal (=1B on ASTM3359 scale) |

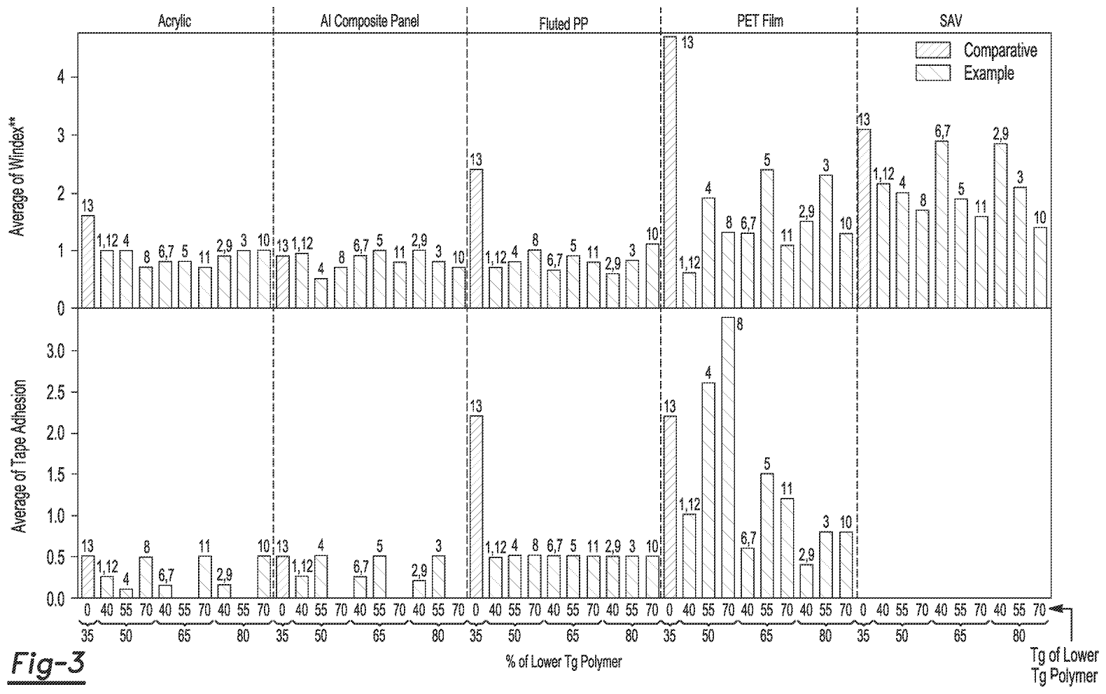

The results for each of the chemical resistance test and the tape adhesion test are shown in FIG. 3. These results depict the average results for the data points obtained with the black prints and with the cyan points. In FIG. 3, the prints are identified by the example multi-phase latex particle composition (1-12) or comparative multi-phase latex particle composition (13) contained in the inks used to generate the prints. The X axis sets forth both the % of the lower T_{g} polymer in the multi-phase latex particle composition and the T_{g} of the lower T_{g} polymer. For both the chemical resistance test and the tape adhesion test, lower scores are better (as shown in Table 12A and Table 12B).

On PLEXIGLAS® (acrylic sheet), INTEPRO® (fluted polypropylene), LINTEC® E2201 (polyethylene terephthalate) and self-adhesive vinyl (SAV), the example prints 1-12 exhibited improved chemical resistance compared to the comparative example print 13. On DIBOND® (aluminium composite panel), the example prints 1-12 exhibited similar chemical resistance or better chemical resistance when compared to the comparative example print 13.

On INTEPRO® (fluted polypropylene), the example prints 1-12 exhibited significantly better tape adhesion performance when compared to the comparative example print 13. On LINTEC® E2201 (polyethylene terephthalate), most of the example prints 1-3, 5-7, and 9-12 exhibited better tape adhesion performance when compared to the comparative example print 13, and while not quite as good as comparative example print 13, example prints 4 and 8 also exhibited acceptable tape adhesion performance on LINTEC® E2201. On PLEXIGLAS® (acrylic sheet) and DIBOND® (aluminium composite panel), the example prints 1-12 exhibited similar tape adhesion performance or better tape adhesion performance when compared to the comparative example print 13.

The black prints generated on SAV were also tested for elongation. The elongation test involved printing images of uniform color and ink density (area fills) with black (K) inks, these area fills being approximately 6 inches high by 5 inches wide. The area fills were cut into 1 inch wide sections or strips (6 inches long). Four of these strips were stretched to varying extents corresponding to 15%, 30%, 60% and 90% of the original length, and the remaining strip was left un-stretched. The color (L*, A and B) of each strip was then measured at 5 different locations evenly spaced over the length of the strip. The change in color, or ΔE, of each stretched strip was calculated in relation to the unstretched strip. The elongation scale is from 1-15, where DE (ΔE) above 7 at 90% elongation indicates that the ink prints were starting to show a low level of cracking. This test is a good indication of how the printed samples will perform, for example, when used in car wrap or other like applications where the images are stretched to varying extents to conform around the curves and irregular shapes of the vehicle exterior or other object. A typical goal is to limit color change at 30% elongation to less than 2 ΔE units.

The results for the elongation test are shown in FIG. 4 (bottom bar graph). Most of the example prints, namely prints 1-3, 5-7, 9, 11, and 12, exhibited good elongation performance.

The average results of the chemical resistance test for the black and cyan prints on SAV (from FIG. 3) are also reproduced in the bottom bar graph of FIG. 4. Together, the results for chemical resistance and elongation illustrate that the example multi-phase latex particle compositions can improve chemical resistance while maintaining acceptable elongation performance.

### Example 2

Three additional examples (14-16) of the multi-phase latex particle composition disclosed herein were prepared. Three additional comparative examples (17-19) of the multi-phase latex particle composition disclosed herein were also prepared. In these comparative examples, the cumulative percentage of heteropolymers including less than 30% of a C6 or greater (meth)acrylate monomer was 100 wt %.

In these examples and comparative examples, the first heteropolymer was made as a separate latex, and then was used as a seed in subsequent reactions. The first stage heteropolymer latex was made at the appropriate particle size such that when used at a 20% loading on total polymer, the resulting final particle sizes were similar to examples and comparative examples 1-13.

Table 13 sets forth some properties of the example multi-phase latex particle compositions 14-16 and the comparative example multi-phase latex particle compositions 17-19. Table 11 also sets forth the following with regard to each of the first and second stage heteropolymers of the example and comparative multi-phase latex particle compositions: % of total polymer present in the multi-phase latex particle composition, T_{g} measured using DSC, the feed time of the second monomer stream to the reactor, and the composition of the monomer stream (wt % active).

TABLE 13

| Example ID | | | Comparative Example ID | | |
|---|---|---|---|---|---|
| 14 | 15 | 16 | 17 | 18 | 19 |

Latex Particle Composition Properties

| | | | | | | |
|---|---|---|---|---|---|---|
| solids content | 37.6% | 37.4% | 37.8% | 44.0% | 43.8% | 38.0% |
| (%) | | | | | | |
| particle size | 232 | 230 | 232 | 234 | 246 | 225 |
| (D50, nm) | | | | | | |

First Stage Heteropolymer

| | | | | | | |
|---|---|---|---|---|---|---|
| % of total | 20% | 20% | 20% | 20% | 20% | 20% |
| polymer | | | | | | |
| Tg (° C.) | 22 | 22 | 22 | 22 | 22 | 22 |
| (estimate) | | | | | | |
| feed time to | N/A | N/A | N/A | N/A | N/A | N/A |
| reactor (min) | | | | | | |

composition

| | | | | | | |
|---|---|---|---|---|---|---|
| n-butyl | 87.3% | 87.3% | 87.3% | 87.3% | 87.3% | 87.3% |
| methacrylate | | | | | | |
| butyl | 10.0% | 10.0% | 10.0% | 10.0% | 10.0% | 10.0% |
| acryloyloxyethyl | | | | | | |
| carbamate | | | | | | |
| methacrylic | 1.5% | 1.5% | 1.5% | 1.5% | 1.5% | 1.5% |
| acid | | | | | | |
| HITENOL ® | 1.3% | 1.3% | 1.3% | 1.3% | 1.3% | 1.3% |
| AR10 | | | | | | |

Second Stage Heteropolymer

| | | | | | | |
|---|---|---|---|---|---|---|
| % of total | 80% | 80% | 80% | 80% | 80% | 80% |
| polymer | | | | | | |
| Tg (° C.) | 87 | 85 | 85 | 92 | 91 | 88 |
| (estimate) | | | | | | |
| feed time to | 210 | 210 | 210 | 210 | 210 | 210 |
| reactor (min) | | | | | | |

composition

| | | | | | | |
|---|---|---|---|---|---|---|
| cyclohexyl | 43.2% | 57.6% | 72.0% | 0.0% | 14.4% | 28.8% |
| methacrylate | | | | | | |
| phenoxyethyl | 10.0% | 10.0% | 10.0% | 10.0% | 10.0% | 10.0% |
| methacrylate | | | | | | |
| methyl | 28.8% | 14.4% | 0.0% | 72.0% | 57.6% | 43.2% |
| methacrylate | | | | | | |
| n-butyl acrylate | 5.0% | 5.0% | 5.0% | 5.0% | 5.0% | 5.0% |
| butyl | 5.0% | 5.0% | 5.0% | 5.0% | 5.0% | 5.0% |
| acryloyloxyethyl | | | | | | |
| carbamate | | | | | | |
| diacetone | 3.0% | 3.0% | 3.0% | 3.0% | 3.0% | 3.0% |
| acrylamide | | | | | | |
| methacrylic | 3.0% | 3.0% | 3.0% | 3.0% | 3.0% | 3.0% |
| acid | | | | | | |
| HITENOL ® | 2.0% | 2.0% | 2.0% | 2.0% | 2.0% | 2.0% |
| AR10 | | | | | | |

Each of the example multi-phase latex particle compositions and the comparative multi-phase latex particle composition was incorporated into an ink with the formulation set forth in FIG. 11A.

Each of the example inks and the comparative example inks were inkjet printed (using a thermal inkjet printer) on three different rigid media, including PLEXIGLAS® (acrylic sheet), DIBOND® (aluminium composite panel), and INTEPRO® (fluted polypropylene), and on two different flexible media, including LINTEC® E2201 (polyethylene terephthalate) and self-adhesive vinyl (SAV). The overcoat fluid of Example 1 was also printed in a similar manner as described in Example 1. The printed media were then exposed to heat at the respective temperatures set forth in Example 1.

Each example print 14-16 and comparative example print 17-19 was exposed to the same chemical resistance test described in Example 1. All of the tested patches were visually inspected for ink defects, such as ink removal, smear, etc., and graded according to the scale described in Table 12A.

The example prints 14-16 and comparative example prints 17-19 generated on PLEXIGLAS® (acrylic sheet), DIBOND® (aluminium composite panel), INTEPRO® (fluted polypropylene), and LINTEC® E2201 (polyethylene terephthalate) were also exposed to the tape adhesion test described in Example 1. All of the tested patches were visually inspected for ink defects, such as ink removal, smear, etc., and graded according to the scale described in Table 12B.

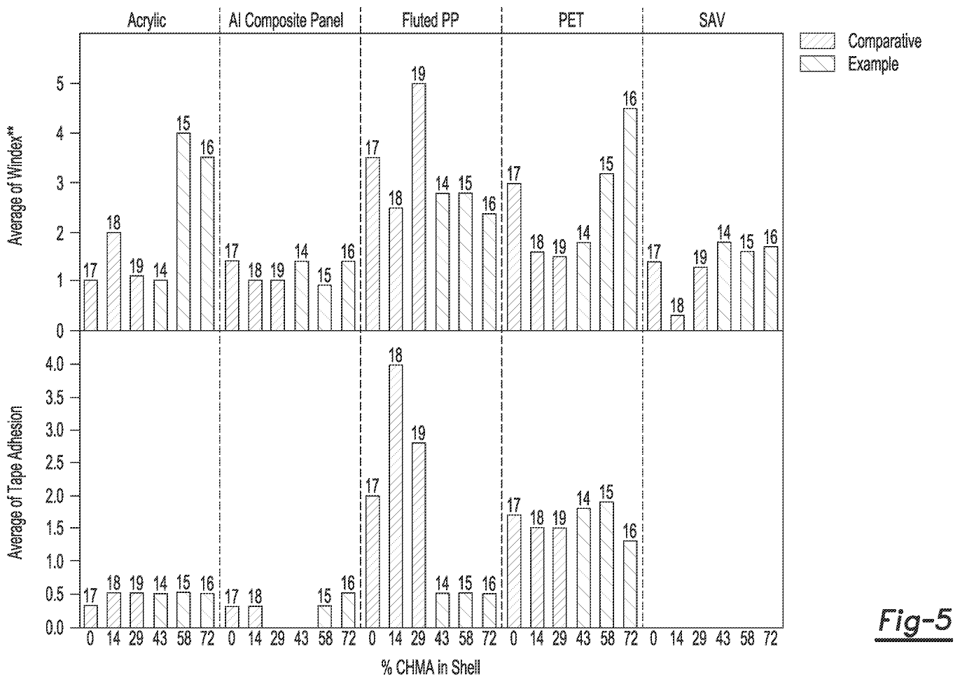

The results for each of the chemical resistance test and the tape adhesion test are shown in FIG. 5. These results depict the average results for the data points obtained with the black prints and with the cyan points. In FIG. 5, the prints are identified by the example multi-phase latex particle composition (14-16) or comparative multi-phase latex particle composition (17-19) contained in the inks used to generate the prints. The X axis sets forth the percentage of CHMA (the C6 or greater monomer) in the shell heteropolymer. For both the chemical resistance test and the tape adhesion test, lower scores are better (as shown in Table 12A and Table 12B).

On DIBOND® (aluminium composite panel) and SAVE, the example prints 14-16 exhibited similar chemical resistance when compared to the comparative example prints 17-19. On PLEXIGLAS® (acrylic sheet), DIBOND® (aluminium composite panel), and LINTEC® E2201 (polyethylene terephthalate), the example prints 14-16 exhibited similar tape adhesion performance tape adhesion performance when compared to the comparative example prints 17-19.

On INTEPRO® (fluted polypropylene), the example prints 14-16 exhibited better chemical resistance and significantly better tape adhesion compared to the comparative example prints 17-19. The higher levels of the C6 or greater monomer (CHMA in these examples) clearly increased adhesion of the latex ink to the fluted polypropylene media. The higher levels of the C6 or greater monomer (CHMA in these examples) can deleteriously affect the chemical resistance (as shown by example prints 15 and 16 on PLEXIGLAS® (acrylic sheet) and LINTEC® E2201 (polyethylene terephthalate)), and thus the amounts of the C6 or greater monomer disclosed herein help to achieve a desirable balance.

While the results are not shown, examples prints 14-16 also exhibited acceptable elongation performance on SAV media.

It is to be understood that the ranges provided herein include the stated range and any value or sub-range within the stated range, as if the value(s) or sub-range(s) within the stated range were explicitly recited. For example, a range from about 5 wt % active to about 20 wt % active, should be interpreted to include not only the explicitly recited limits of from about 5 wt % active to about 20 wt % active, but also to include individual values, such as about 5.75 wt % active, 8 wt % active, 11 wt % active, 14.5 wt % active, etc., and sub-ranges, such as from about 5 wt % active to about 15 wt % active, from about 6 wt % active to about 10 wt % active, from about 12.75 wt % active to about 19.75 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A multi-phase latex particle composition, comprising:
at least two different heteropolymers defining at least two different phases of the multi-phase latex particle composition;
wherein the at least two different heteropolymers are selected such that:
a cumulative percentage of any heteropolymers of the at least two different heteropolymers including less than 30% of a C6 or greater (meth)acrylate monomer ranges from about 20 wt % to about 80 wt % of a total weight of the multi-phase latex particle composition;
a cumulative percentage of any heteropolymers of the at least two different heteropolymers having a glass transition temperature (T_{g}) ranging from 15° C. to 75° C. ranges from about 20 wt % to about 70 wt % of the total weight of the multi-phase latex particle composition;
a cumulative percentage of any heteropolymers of the at least two different heteropolymers having a glass transition temperature (T_{g}) greater than 75° C. is greater than 30 wt % of the total weight of the multi-phase latex particle composition;
a cumulative percentage of any heteropolymers of the at least two different heteropolymers having a glass transition temperature (T_{g}) less than 15° C. is less than 20 wt % of the total weight of the multi-phase latex particle composition; and
a cumulative percentage of an aromatic group monomer in the multi-phase latex particle composition is less than 10 wt % of the total weight of the multi-phase latex particle composition.

2. The multi-phase latex particle composition as defined in claim 1, wherein:
a first heteropolymer of the at least two different heteropolymers includes less than 30% of the C6 or greater (meth)acrylate monomer and has the Tg ranging from 15° C. to 75° C.; and
a second heteropolymer of the at least two different heteropolymers includes greater than 30% of the C6 or greater (meth)acrylate monomer and has the Tg greater than 75° C.

3. The multi-phase latex particle composition as defined in claim 2, wherein:
the first heteropolymer makes up from about 50 wt % to about 70 wt % of the total weight of the multi-phase latex particle composition; and
the second heteropolymer makes up from greater than 30 wt % to about 50 wt % of the total weight of the multi-phase latex particle composition.

4. The multi-phase latex particle composition as defined in claim 2, wherein:
the first heteropolymer consists of a C5 or fewer (meth)acrylate monomer, a first adhesion promoting monomer, a first acidic monomer, and a first polymerizable surfactant; and
the second heteropolymer consists of the C6 or greater (meth)acrylate monomer, a second adhesion promoting monomer, a second acidic monomer, a second polymerizable surfactant, the aromatic group monomer, and optionally a chain transfer agent.

5. The multi-phase latex particle composition as defined in claim 4, wherein:
the C5 or fewer (meth)acrylate monomer is selected from the group consisting of methyl (meth)acrylate, n-butyl (meth)acrylate, t-butyl (meth)acrylate, i-butyl (meth)acrylate, ethyl (meth)acrylate, n-propyl (meth)acrylate, iso-propyl (meth)acrylate, n-pentyl (meth)acrylate, iso-pentyl (meth)acrylate, and combinations thereof; and
the C6 or greater (meth)acrylate monomer is selected from the group consisting of cyclohexyl (meth)acrylate, isobornyl (meth)acrylate, 2-ethylhexacrylate, trimethylcyclohexyl (meth)acrylate, isodecyl methacrylate, lauryl methacrylate, iso-tridecyl methacrylate, stearyl methacrylate, behenyl methacrylate, dicyclopentadienyl acrylate, and combinations thereof.

6. The multi-phase latex particle composition as defined in claim 1, wherein:
a first heteropolymer of the at least two different heteropolymers includes greater than 30% of the C6 or greater (meth)acrylate monomer and has the Tg ranging from 15° C. to 75° C.; and
a second heteropolymer of the at least two different heteropolymers includes less than 30% of the C6 or greater (meth)acrylate monomer and has the Tg greater than 75° C.

7. The multi-phase latex particle composition as defined in claim 6, wherein:
the first heteropolymer makes up from about 30 wt % to about 45 wt % of the total weight of the multi-phase latex particle composition; and
the second heteropolymer makes up from about 55 wt % to about 70 wt % of the total weight of the multi-phase latex particle composition.

8. The multi-phase latex particle composition as defined in claim 6, wherein:
the first heteropolymer consists of the C6 or greater (meth)acrylate monomer, at least one adhesion promoting monomer, a first acidic monomer, and a first polymerizable surfactant; and
the second heteropolymer consists of a C5 or fewer (meth)acrylate monomer, the C6 or greater (meth)acrylate monomer, the at least one adhesion promoting monomer, a second acidic monomer, and a second polymerizable surfactant.

9. The multi-phase latex particle composition as defined in claim 6, wherein:
the C6 or greater (meth)acrylate monomer is selected from the group consisting of cyclohexyl (meth)acrylate, isobornyl (meth)acrylate, 2-ethylhexacrylate, trimethylcyclohexyl (meth)acrylate, isodecyl methacrylate, lauryl methacrylate, iso-tridecyl methacrylate, stearyl methacrylate, behenyl methacrylate, dicyclopentadienyl acrylate, and combinations thereof; and
the C5 or fewer (meth)acrylate monomer is selected from the group consisting of methyl (meth)acrylate, n-butyl (meth)acrylate, t-butyl (meth)acrylate, i-butyl (meth)acrylate, ethyl (meth)acrylate, n-propyl (meth)acrylate, iso-propyl (meth)acrylate, n-pentyl (meth)acrylate, iso-pentyl (meth)acrylate, and combinations thereof.

10. The multi-phase latex particle composition as defined in claim 1, wherein at least one of the at least two different heteropolymers is cross-linked.

11. An ink composition, comprising:
a pigment;
latex particles made up of the multi-phase latex particle composition of claim 1; and
an aqueous vehicle.

12. The ink composition as defined in claim 11, wherein the latex particles are present in an amount ranging from about 5 wt % active to about 20 wt % active of a total weight of the ink composition.

13. The ink composition as defined in claim 11, wherein:
a first heteropolymer of the at least two different heteropolymers includes less than 30% of the C6 or greater (meth)acrylate monomer and has the Tg ranging from 15° C. to 75° C.; and
a second heteropolymer of the at least two different heteropolymers includes greater than 30% of the C6 or greater (meth)acrylate monomer and has the Tg greater than 75° C.

14. The ink composition as defined in claim 11, wherein:
a first heteropolymer of the at least two different heteropolymers includes greater than 30% of the C6 or greater (meth)acrylate monomer and has the Tg ranging from 15° C. to 75° C.; and
a second heteropolymer of the at least two different heteropolymers includes less than 30% of the C6 or greater (meth)acrylate monomer and has the Tg greater than 75° C.

15. A method, comprising:
inkjet printing an ink composition onto a non-porous substrate, the ink composition including:
a pigment;
latex particles made up of the multi-phase latex particle composition of claim 1; and
an aqueous vehicle.
